(19) United States
(12) Patent Application Publication
(10) Pub. No.: US 2018/0059788 A1
(43) Pub. Date: Mar. 1, 2018

(54) METHOD FOR PROVIDING VIRTUAL REALITY, PROGRAM FOR EXECUTING THE METHOD ON COMPUTER, AND INFORMATION PROCESSING APPARATUS

(71) Applicant: COLOPL, Inc., Tokyo (JP)

(72) Inventors: Yasuhiro NOGUCHI, Tokyo (JP); Futoshi KAJITA, Tokyo (JP); Atsushi INOMATA, Kanagawa (JP)

(21) Appl. No.: 15/683,446

(22) Filed: Aug. 22, 2017

(30) Foreign Application Priority Data
Aug. 23, 2016 (JP) 2016-162574
Aug. 23, 2016 (JP) 2016-162575
Aug. 23, 2016 (JP) 2016-162576
Oct. 31, 2016 (JP) 2016-213147

(51) Int. Cl. G06F 3/01; A63F 13/25; A63F 13/52; A63F 13/211; A63F 13/35; A63F 13/212; G06T 19/00

(52) U.S. Cl. CPC G06F 3/014; A63F 13/25; A63F 13/52; A63F 2300/8082; A63F 13/35; A63F 13/212; G06T 19/00; A63F 13/211

(57) ABSTRACT

A method to be executed by a computer. The method includes defining a virtual space. The method further includes displaying in the virtual space an operation object. The method further includes detecting a motion of a part of a body of the user. The method further includes moving the operation object in synchronization with the detected motion. The method further includes monitoring a monitoring target and changing a display mode of the operation object or an accompanying object accompanying the operation object in accordance with a change in the monitoring target.

### RELATED APPLICATIONS

The present application claims priority to Japanese applications Nos. 2016-162574, 2016-162575, and 2016-162576 all filed Aug. 23, 2016, and Japanese application No. 2016-213147 filed Oct. 31, 2016. The disclosures of all above-listed Japanese applications are hereby incorporated by reference herein in their entirety.

### TECHNICAL FIELD

This disclosure relates to a technology of providing virtual reality, and more specifically, to a technology of increasing a sense of immersion in virtual reality.

### BACKGROUND ART

In Patent Document 1, there is described a technology for “improving usability when achieving gesture input using an HMD”.

In Patent Document 2, there is described an electronic watch configured to display a battery mark on a display section in accordance with a remaining battery power.

### RELATED ART

### Patent Documents

[Patent Document 1] JP 2015-231445 A
[Patent Document 1] JP 2015-102342 A

### SUMMARY

In Patent Document 1 and Patent Document 2, there is room for further improvement in virtual experience.

The above-mentioned and other objects, features, aspects, and advantages of technical features to be disclosed may be made clear from the following detailed description of this disclosure, which is to be understood in association with the attached drawings.

### BRIEF DESCRIPTION OF THE DRAWINGS

FIG. 1 A diagram of an overview of a configuration of an HMD system according to at least one embodiment of this disclosure.

FIG. 2 A block diagram of an example of a hardware configuration of a computer according to at least one embodiment of this disclosure.

FIG. 3 A diagram of a uvw visual-field coordinate system to be set for an HMD of at least one embodiment of this disclosure.

FIG. 4 A diagram of a mode of expressing a virtual space of at least one embodiment of this disclosure.

FIG. 5 A plan view diagram of a head of a user wearing the HMD of at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller of at least one embodiment of this disclosure.

FIG. 8B A diagram of a hand of a user of at least one embodiment of this disclosure.

FIG. 9 A diagram of a state in which an object is arranged in a field-of-view region 23 of a virtual space 2 according to at least one embodiment of this disclosure.

FIG. 10A A diagram of a mode of movement of a grid 950 arranged in the field-of-view region 23 of the virtual space 2 according to at least one embodiment of this disclosure.

FIG. 10B A diagram of a mode of movement of a grid 950 arranged in the field-of-view region 23 of the virtual space 2 according to at least one embodiment of this disclosure.

FIG. 11 A block diagram of a computer 200 of at least one embodiment of this disclosure as a module configuration.

FIG. 12 A flowchart of processing to be executed by an HMD system 100 according to at least one embodiment of this disclosure.

FIG. 13 A flowchart of processing to be executed by a processor 10 of the computer 200 according to at least one embodiment of this disclosure.

FIG. 14A A diagram of a state in which objects 1410 are arranged in the virtual space 2 according to at least one embodiment of this disclosure.

FIG. 14B A diagram of a state in which objects 1410 are arranged in the virtual space 2 according to at least one embodiment of this disclosure.

FIG. 15A A diagram of a state in which the objects 1410 are arranged in the virtual space 2 according to at least one embodiment of this disclosure.

FIG. 15B A diagram of a state in which the objects 1410 are arranged in the virtual space 2 according to at least one embodiment of this disclosure.

FIG. 16A A diagram of a state in which the objects 1410 are arranged in the virtual space 2 according to at least one embodiment of this disclosure.

FIG. 16B A diagram of a state in which the objects 1410 are arranged in the virtual space 2 according to at least one embodiment of this disclosure.

FIG. 17A A diagram of a state in which the objects 1410 are arranged in the virtual space 2 according to at least one embodiment of this disclosure.

FIG. 17B A diagram of a state in which the objects 1410 are arranged in the virtual space 2 according to at least one embodiment of this disclosure.

FIG. 18A A diagram of a state in which the objects 1410 are arranged in the virtual space 2 according to at least one embodiment of this disclosure.

FIG. 18B A diagram of a state in which the objects 1410 are arranged in the virtual space 2 according to at least one embodiment of this disclosure.

FIG. 19 A block diagram of the computer 200 of at least one embodiment of this disclosure as a module configuration.

FIG. 20 A flowchart of processing to be executed by the HMD system 100 according to at least one embodiment of this disclosure.

FIG. 21 A flowchart of processing to be executed by the processor 10 of the computer 200 in at least one embodiment of this disclosure.

FIG. 22A A diagram of a visual-field image 2200 recognized by a user 190 in the virtual space 2 of at least one embodiment of this disclosure.

FIG. 22B A diagram of a visual-field image 2200 recognized by a user 190 in the virtual space 2 of at least one embodiment of this disclosure.

FIG. 23A A diagram of virtual hand objects for shaking hands with another player present in the same virtual space 2 in at least one embodiment of this disclosure.

FIG. 23B A diagram of virtual hand objects for shaking hands with another player present in the same virtual space 2 in at least one embodiment of this disclosure.

FIG. 23B A diagram of a virtual hand object for shaking hands with another player present in the same virtual space 2 in at least one embodiment of this disclosure.

FIG. 24A A diagram of a mode of waving hands in the virtual space 2 of at least one embodiment of this disclosure.

FIG. 24B A diagram of a mode of waving hands in the virtual space 2 of at least one embodiment of this disclosure.

FIG. 25 A diagram of an arrangement of objects in the field-of-view region 23 of at least one embodiment of this disclosure.

FIG. 26 A diagram of an arrangement of objects in the field-of-view region 23 of at least one embodiment of this disclosure.

FIG. 27 A block diagram of the computer 200 of at least one embodiment of this disclosure as a module configuration.

FIG. 28 A flowchart of processing to be executed by the HMD system 100 according to at least one embodiment of this disclosure.

FIG. 29 A flowchart of processing to be executed by the processor 10 of the computer 200 in at least one embodiment of this disclosure.

FIG. 30A A diagram of a state in which a controller object is not arranged according to at least one embodiment of this disclosure.

FIG. 30B A diagram of a state in which a controller object is not arranged according to at least one embodiment of this disclosure.

FIG. 31A A diagram of a state in which a controller object 2500 is arranged according to at least one embodiment of this disclosure.

FIG. 31B A diagram of a state in which a controller object 2500 is arranged according to at least one embodiment of this disclosure.

FIG. 32A A diagram of a state in which a left-hand object 2510 and a right-hand object 2520 are associated with the controller object 2500 according to at least one embodiment of this disclosure.

FIG. 32B A diagram of a state in which a left-hand object 2510 and a right-hand object 2520 are associated with the controller object 2500 according to at least one embodiment of this disclosure.

FIG. 33A A diagram of a state in which the left-hand object 2510 and the right-hand object 2520 have operated the controller object 2500 to rotate the controller object 2500 in a right direction according to at least one embodiment of this disclosure.

FIG. 33B A diagram of a state in which the left-hand object 2510 and the right-hand object 2520 have operated the controller object 2500 to rotate the controller object 2500 in a right direction according to at least one embodiment of this disclosure.

FIG. 34 A block diagram of the computer of at least one embodiment of this disclosure as a module configuration.

FIG. 35 A flowchart of processing to be executed by the HMD system according to at least one embodiment of this disclosure.

FIG. 36 A flowchart of control of a virtual hand object to be executed by the processor 10 of the computer according to at least one embodiment of this disclosure.

FIG. 37A A diagram of a part of the processing in FIG. 36 according to at least one embodiment of this disclosure.

FIG. 37B A diagram of a part of the processing in FIG. 36 according to at least one embodiment of this disclosure.

FIG. 38 A diagram of a texture table of at least one embodiment of this disclosure.

FIG. 39 A diagram of a display mode of operation objects of at least one embodiment of this disclosure.

FIG. 40 A diagram of a display mode of operation objects in at least one embodiment of this disclosure.

FIG. 41 A diagram of a display mode of an accompanying object of at least one embodiment of this disclosure.

FIG. 42A A diagram of a display mode of an accompanying object in at least one embodiment of this disclosure.

FIG. 42A A diagram of a display mode of an accompanying object in at least one embodiment of this disclosure.

### DETAILED DESCRIPTION

Now, with reference to the drawings, at least one embodiment of this disclosure is described in detail. In the following description, like components are denoted by like reference symbols. The same applies to the names and functions of those components. Therefore, detailed description of those components is not repeated.

[Configuration of HMD System]

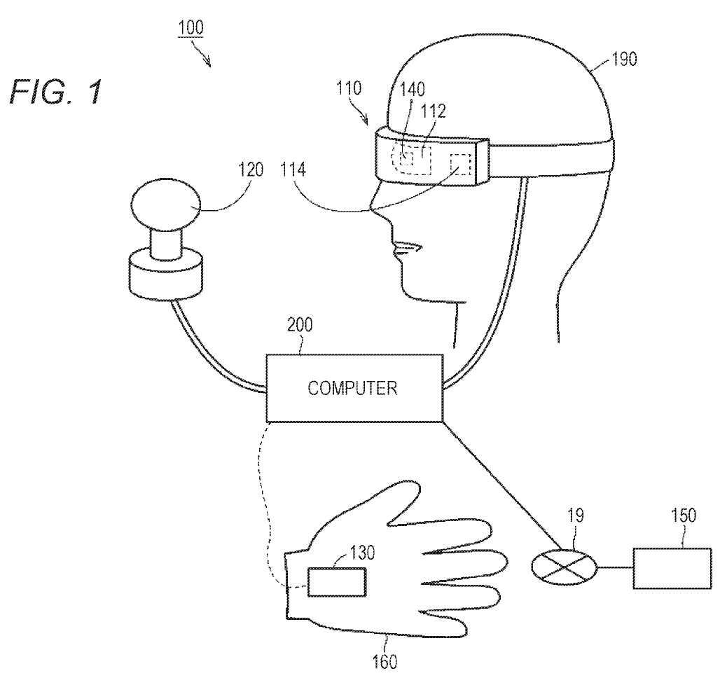

With reference to FIG. 1, a configuration of a head-mounted device (HMD) system 100 is described. FIG. 1 is a diagram of the overview of the configuration of the HMD system 100 according to at least one embodiment of this disclosure. In one aspect, the HMD system 100 is provided as a system for household use or a system for professional use. An HMD may include both of a so-called head-mounted display including a monitor and a head-mounted device to which a smart phone or other terminals having a monitor can be mounted.

The HMD system 100 includes an HMD 110, an HMD sensor 120, a controller 160, and a computer 200. The HMD 110 includes a monitor 112 and an eye gaze sensor 140. The controller 160 may include a motion sensor 130.

In at least one aspect, the computer 200 can be connected to a network 19, for example, the Internet, and can communicate to/from a server 150 or other computers connected to the network 19. In at least aspect, the HMD 110 may include a sensor 114 instead of the HMD sensor 120.

The HMD 110 may be worn on a head of a user to provide a virtual space to the user during operation. More specifically, the HMD 110 displays each of a right-eye image and a left-eye image on the monitor 112. When each eye of the user visually recognizes each image, the user may recognize the image as a three-dimensional image based on the parallax of both the eyes.

The monitor 112 is achieved as, for example, a non-transmissive (or partially transmissive) display device. In at least one aspect, the monitor 112 is arranged on a main body of the HMD 110 so as to be positioned in front of both the eyes of the user. Therefore, when the user visually recognizes the three-dimensional image displayed on the monitor 112, the user can be immersed in the virtual space. According to at least one embodiment of this disclosure, the virtual space includes, for example, a background, objects that can be operated by the user, and menu images that can be selected by the user. According to at least one embodiment of this disclosure, the monitor 112 may be achieved as a liquid crystal monitor or an organic electroluminescence (EL) monitor included in a so-called smart phone or other information display terminals.

In at least one aspect, the monitor 112 may include a sub-monitor for displaying a right-eye image and a sub-monitor for displaying a left-eye image. In at least one aspect, the monitor 112 may be configured to integrally display the right-eye image and the left-eye image. In this case, the monitor 112 includes a high-speed shutter. The high-speed shutter operates so as to enable alternate display of the right-eye image and the left-eye image so that only one of the eyes can recognize the image.

In at least one aspect, the HMD 110 includes a plurality of light sources (not shown). Each light source is achieved by, for example, a light emitting diode (LED) configured to emit an infrared ray. The HMD sensor 120 has a position tracking function for detecting the movement of the HMD 110. More specifically, the HMD sensor 120 is configured to read a plurality of infrared rays emitted by the HMD 110, and to detect the position and the inclination of the HMD 110 in a real space.

In at least one aspect, the HMD sensor 120 may be achieved by a camera. In this case, the HMD sensor 120 may use image information of the HMD 110 output from the camera to execute image analysis processing, to thereby enable detection of the position and the inclination of the HMD 110.

In at least one aspect, the HMD 110 may include the sensor 114 instead of the HMD sensor 120 as a position detector. The HMD 110 may use the sensor 114 to detect the position and the inclination of the HMD 110 itself. For example, when the sensor 114 is an angular velocity sensor, a geomagnetic sensor, an acceleration sensor, or a gyrosensor, the HMD 110 may use any of those sensors instead of the HMD sensor 120 to detect the position and the inclination of the HMD 110 itself. As an example, when the sensor 114 is an angular velocity sensor, the angular velocity sensor detects over time the angular velocity about each of three axes of the HMD 110 in the real space. The HMD 110 calculates a temporal change of the angle about each of the three axes of the HMD 110 based on each angular velocity, and further calculates an inclination of the HMD 110 based on the temporal change of the angles. Further, the HMD 110 may include a transmissive display device. In this case, the transmissive display device may be configured as a display device that is temporarily non-transmissive by adjusting the transmittance of the display device. The visual-field image may include a section for presenting a real space on a part of the image forming the virtual space. For example, an image taken by a camera mounted to the HMD 110 may be superimposed and displayed on a part of the visual-field image, or the real space may be visually recognized from a part of the visual-field image by increasing the transmittance of a part of the transmissive display device.

The eye gaze sensor 140 is configured to detect a direction (line-of-sight direction) in which the lines of sight of the right eye and the left eye of a user 190 are directed. The direction is detected by, for example, a known eye tracking function. The eye gaze sensor 140 is achieved by a sensor having the eye tracking function. In at least one aspect, the eye gaze sensor 140 includes a right-eye sensor and a left-eye sensor. The eye gaze sensor 140 may be, for example, a sensor configured to irradiate the right eye and the left eye of the user 190 with infrared light, and to receive reflection light from the cornea and the iris with respect to the irradiation light, to thereby detect a rotational angle of each eyeball. The eye gaze sensor 140 can detect the line-of-sight direction of the user 190 based on each detected rotational angle.

The server 150 may transmit a program to the computer 200. In at least one aspect, the server 150 may communicate to/from another computer 200 for providing virtual reality to an HMD used by another user. For example, when a plurality of users play a participatory game in an amusement facility, each computer 200 communicates to/from another computer 200 with a signal based on the motion of each user, to thereby enable the plurality of users to enjoy a common game in the same virtual space.

The controller 160 is connected to the computer 200 through wireless communication. The controller 160 is configured to receive input of a command from the user 190 to the computer 200. In at least one aspect, the controller 160 can be held by the user 190. In at least one aspect, the controller 160 can be mounted to the body or a part of the clothes of the user 190. In at least one aspect, the controller 160 may be configured to output at least any one of a vibration, a sound, or light based on the signal transmitted from the computer 200. In at least one aspect, the controller 160 is configured to receive from the user 190 an operation for controlling the position and the movement of an object arranged in the virtual space.

In at least one aspect, the motion sensor 130 is mounted on the hand of the user to detect the movement of the hand of the user. For example, the motion sensor 130 detects a rotational speed and the number of rotations of the hand. The detected signal is transmitted to the computer 200 from the controller 160. The motion sensor 130 is provided to, for example, the glove-type controller 160. According to at least one embodiment of this disclosure, for the safety in the real space, the controller 160 is mounted on an object like a glove-type object that does not easily fly away by being worn on a hand of the user 190. In at least one aspect, a sensor that is not mounted on the user 190 may detect the movement of the hand of the user 190. For example, a signal of a camera that photographs the user 190 may be input to the computer 200 as a signal representing the motion of the user 190. As at least one example, the motion sensor 130 and the computer 200 are connected to each other through wireless communication. In the case of wireless communication, the communication mode is not particularly limited, and for example, Bluetooth® or other known communication methods may be used.

[Hardware Configuration]

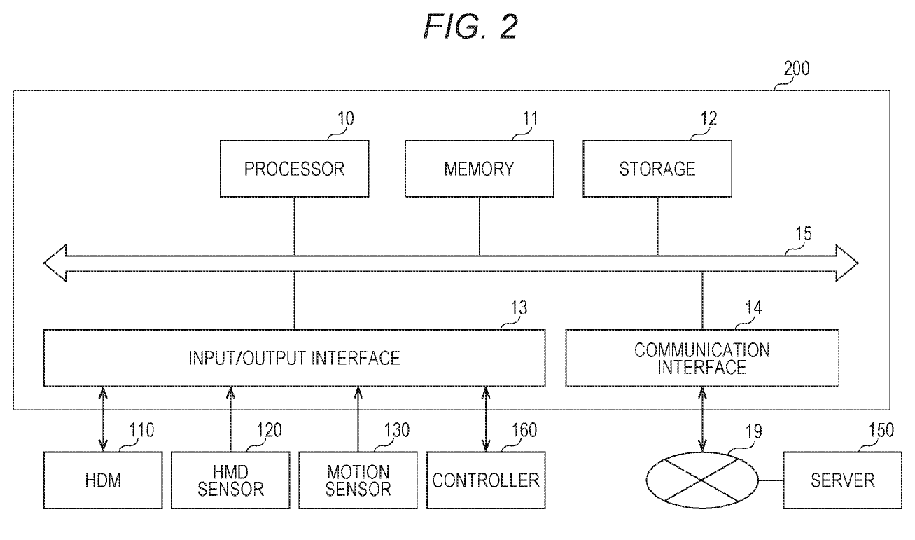

With reference to FIG. 2, the computer 200 of at least one embodiment is described. FIG. 2 is a block diagram of an example of the hardware configuration of the computer 200 in at least one aspect. The computer 200 includes, as primary components, a processor 10, a memory 11, a storage 12, an input/output interface 13, and a communication interface 14. Each component is connected to a bus 15.

The processor 10 is configured to execute a series of commands included in a program stored in the memory 11 or the storage 12 based on a signal transmitted to the computer 200 or on satisfaction of a condition determined in advance. In at least one aspect, the processor 10 is achieved as a central processing unit (CPU), a micro-processor unit (MPU), a field-programmable gate array (FPGA), or other devices.

The memory 11 temporarily stores programs and data. The programs are loaded from, for example, the storage 12. The data includes data input to the computer 200 and data generated by the processor 10. In at least one aspect, the memory 11 is achieved as a random access memory (RAM) or other volatile memories.

The storage 12 permanently stores programs and data. The storage 12 is achieved as, for example, a read-only memory (ROM), a hard disk device, a flash memory, or other non-volatile storage devices. The programs stored in the storage 12 include programs for providing a virtual space in the HMD system 100, simulation programs, game programs, user authentication programs, and programs for achieving communication to/from other computers 200. The data stored in the storage 12 includes data and objects for defining the virtual space.

In at least one aspect, the storage 12 may be achieved as a removable storage device like a memory card. In at least one aspect, a configuration that uses programs and data stored in an external storage device may be used instead of the storage 12 built into the computer 200. With such a configuration, for example, in a situation where a plurality of HMD systems 100 are used as in an amusement facility, the programs and the data can be collectively updated.

According to at least one embodiment of this disclosure, the input/output interface 13 is configured to allow communication of signals among the HMD 110, the HMD sensor 120, and the motion sensor 130. In at least one aspect, the input/output interface 13 is achieved with use of a universal serial bus (USB), a digital visual interface (DVI), a high-definition multimedia interface (HDMI)®, or other terminals. The input/output interface 13 is not limited to ones described above.

According to at least one embodiment of this disclosure, the input/output interface 13 may further communicate to/from the controller 160. For example, the input/output interface 13 receives input of a signal output from the controller 160 and the motion sensor 130. In at least one aspect, the input/output interface 13 transmits a command output from the processor 10 to the controller 160. The command instructs the controller 160 to vibrate, output a sound, emit light, or the like. When the controller 160 receives the command, the controller 160 executes anyone of vibration, sound output, and light emission in accordance with the command.

The communication interface 14 is connected to the network 19 to communicate to/from other computers (e.g., the server 150) connected to the network 19. In at least one aspect, the communication interface 14 is achieved as, for example, a local area network (LAN), other wired communication interfaces, wireless fidelity (WiFi), Bluetooth®, near field communication (NFC), or other wireless communication interfaces. The communication interface 14 is not limited to ones described above.

In at least one aspect, the processor 10 accesses the storage 12 and loads one or more programs stored in the storage 12 to the memory 11 to execute a series of commands included in the program. The one or more programs may include an operating system of the computer 200, an application program for providing a virtual space, and game software that can be executed in the virtual space. The processor 10 transmits a signal for providing a virtual space to the HMD 110 via the input/output interface 13. The HMD 110 displays a video on the monitor 112 based on the signal.

In FIG. 2, the computer 200 is provided outside of the HMD 110, but in at least aspect, the computer 200 may be built into the HMD 110. As an example, a portable information communication terminal (e.g., a smart phone) including the monitor 112 may function as the computer 200.

Further, the computer 200 may be used in common among a plurality of HMDs 110. With such a configuration, for example, the same virtual space can be provided to a plurality of users, and hence each user can enjoy the same application with other users in the same virtual space.

According to at least one embodiment of this disclosure, in the HMD system 100, a global coordinate system is set in advance. The global coordinate system has three reference directions (axes) that are respectively parallel to a vertical direction, a horizontal direction orthogonal to the vertical direction, and a front-rear direction orthogonal to both of the vertical direction and the horizontal direction in a real space. In at least one embodiment, the global coordinate system is one type of point-of-view coordinate system. Hence, the horizontal direction, the vertical direction (up-down direction), and the front-rear direction in the global coordinate system are defined as an x axis, a y axis, and a z axis, respectively. More specifically, the x axis of the global coordinate system is parallel to the horizontal direction of the real space, the y axis thereof is parallel to the vertical direction of the real space, and the z axis thereof is parallel to the front-rear direction of the real space.

In at least one aspect, the HMD sensor 120 includes an infrared sensor. When the infrared sensor detects the infrared ray emitted from each light source of the HMD 110, the infrared sensor detects the presence of the HMD 110. The HMD sensor 120 further detects the position and the inclination of the HMD 110 in the real space in accordance with the movement of the user 190 wearing the HMD 110 based on the value of each point (each coordinate value in the global coordinate system). In more detail, the HMD sensor 120 can detect the temporal change of the position and the inclination of the HMD 110 with use of each value detected over time.

The global coordinate system is parallel to a coordinate system of the real space. Therefore, each inclination of the HMD 110 detected by the HMD sensor 120 corresponds to each inclination about each of the three axes of the HMD 110 in the global coordinate system. The HMD sensor 120 sets a uvw visual-field coordinate system to the HMD 110 based on the inclination of the HMD 110 in the global coordinate system. The uvw visual-field coordinate system set to the HMD 110 corresponds to a point-of-view coordinate system used when the user 190 wearing the HMD 110 views an object in the virtual space.

[Uvw Visual-Field Coordinate System]

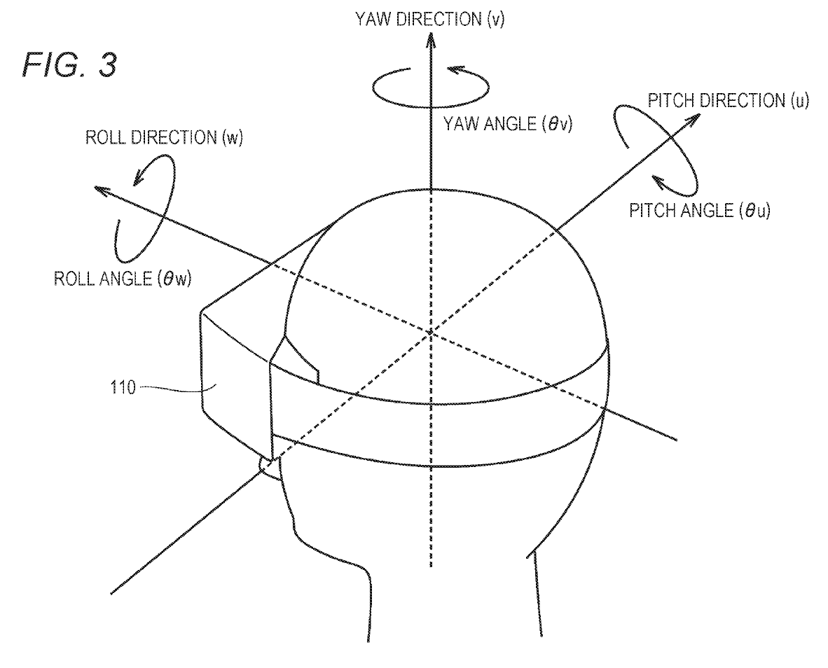

With reference to FIG. 3, the uvw visual-field coordinate system is described. FIG. 3 is a diagram of a uvw visual-field coordinate system to be set for the HMD 110 of at least one embodiment of this disclosure. The HMD sensor 120 detects the position and the inclination of the HMD 110 in the global coordinate system when the HMD 110 is activated. The processor 10 sets the uvw visual-field coordinate system to the HMD 110 based on the detected values.

In FIG. 3, the HMD 110 sets the three-dimensional uvw visual-field coordinate system defining the head of the user wearing the HMD 110 as a center (origin). More specifically, the HMD 110 sets three directions newly obtained by inclining the horizontal direction, the vertical direction, and the front-rear direction (x axis, y axis, and z axis), which define the global coordinate system, about the respective axes by the inclinations about the respective axes of the HMD 110 in the global coordinate system as a pitch direction (u axis), a yaw direction (v axis), and a roll direction (w axis) of the uvw visual-field coordinate system in the HMD 110.

In at least one aspect, when the user 190 wearing the HMD 110 is standing upright and is visually recognizing the front side, the processor 10 sets the uvw visual-field coordinate system that is parallel to the global coordinate system to the HMD 110. In this case, the horizontal direction (x axis), the vertical direction (y axis), and the front-rear direction (z axis) of the global coordinate system directly match with the pitch direction (u axis), the yaw direction (v axis), and the roll direction (w axis) of the uvw visual-field coordinate system in the HMD 110.

After the uvw visual-field coordinate system is set to the HMD 110, the HMD sensor 120 can detect the inclination (change amount of the inclination) of the HMD 110 in the uvw visual-field coordinate system that is set based on the movement of the HMD 110. In this case, the HMD sensor 120 detects, as the inclination of the HMD 110, each of a pitch angle (θu), a yaw angle (θv), and a roll angle (θw) of the HMD 110 in the uvw visual-field coordinate system. The pitch angle (θu) represents an inclination angle of the HMD 110 about the pitch direction in the uvw visual-field coordinate system. The yaw angle (θv) represents an inclination angle of the HMD 110 about the yaw direction in the uvw visual-field coordinate system. The roll angle (θw) represents an inclination angle of the HMD 110 about the roll direction in the uvw visual-field coordinate system.

The HMD sensor 120 sets, to the HMD 110, the uvw visual-field coordinate system of the HMD 110 obtained after the movement of the HMD 110 based on the detected inclination angle of the HMD 110. The relationship between the HMD 110 and the uvw visual-field coordinate system of the HMD 110 is always constant regardless of the position and the inclination of the HMD 110. When the position and the inclination of the HMD 110 change, the position and the inclination of the uvw visual-field coordinate system of the HMD 110 in the global coordinate system change in synchronization with the change of the position and the inclination.

In at least one aspect, the HMD sensor 120 may specify the position of the HMD 110 in the real space as a position relative to the HMD sensor 120 based on the light intensity of the infrared ray or a relative positional relationship between a plurality of points (e.g., a distance between the points), which is acquired based on output from the infrared sensor. Further, the processor 10 may determine the origin of the uvw visual-field coordinate system of the HMD 110 in the real space (global coordinate system) based on the specified relative position.

[Virtual Space]

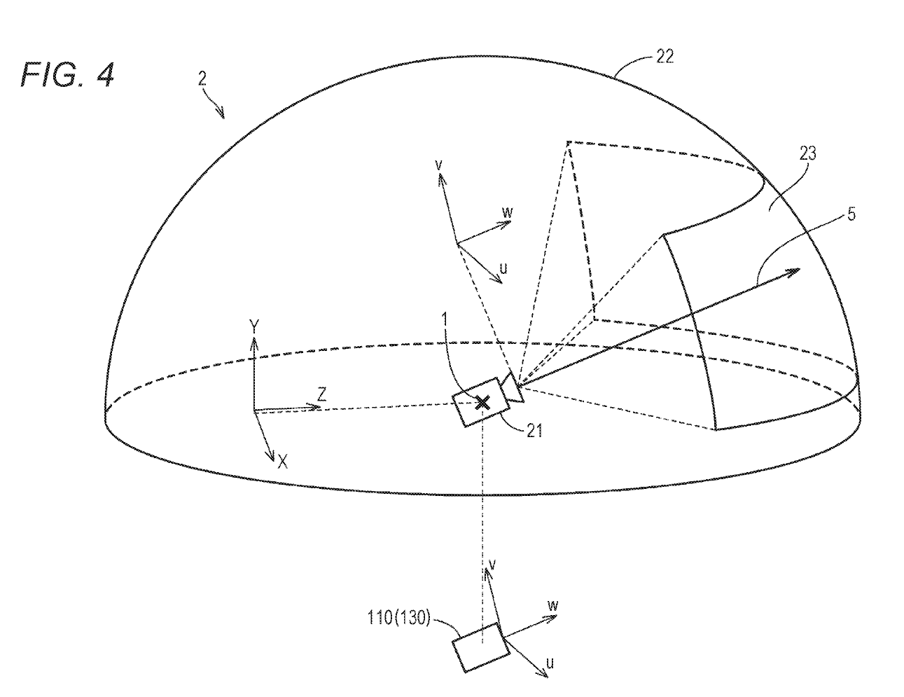

With reference to FIG. 4, the virtual space is further described. FIG. 4 is a diagram of a mode of expressing a virtual space 2 of at least one embodiment of this disclosure. The virtual space 2 has a structure with an entire celestial sphere shape covering a center 21 in all 360-degree directions. In FIG. 4, in order to prevent complicated description, only the upper-half celestial sphere of the virtual space 2 is exemplified. Each mesh section is defined in the virtual space 2. The position of each mesh section is defined in advance as coordinate values in an XYZ coordinate system defined in the virtual space 2. The computer 200 associates each partial image forming content (e.g., still image or moving image) that can be developed in the virtual space 2 with each corresponding mesh section in the virtual space 2, to thereby provide, to the user, the virtual space 2 in which a virtual space image 22 that can be visually recognized by the user is developed.

In at least one aspect, in the virtual space 2, the XYZ coordinate system having the center 21 as the origin is defined. The XYZ coordinate system is, for example, parallel to the global coordinate system. The XYZ coordinate system is one type of the point-of-view coordinate system, and hence the horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the global coordinate system, the Y axis (vertical direction) of the XYZ coordinate system is parallel to the y axis of the global coordinate system, and the Z axis (front-rear direction) of the XYZ coordinate system is parallel to the z axis of the global coordinate system.

When the HMD 110 is activated, that is, when the HMD 110 is in an initial state, a virtual camera 1 is arranged at the center 21 of the virtual space 2. In synchronization with the movement of the HMD 110 in the real space, the virtual camera 1 similarly moves in the virtual space 2. With this, the change in position and direction of the HMD 110 in the real space is reproduced similarly in the virtual space 2.

The uvw visual-field coordinate system is defined in the virtual camera 1 similarly to the case of the HMD 110. The uvw visual-field coordinate system of the virtual camera in the virtual space 2 is defined to be synchronized with the uvw visual-field coordinate system of the HMD 110 in the real space (global coordinate system). Therefore, when the inclination of the HMD 110 changes, the inclination of the virtual camera 1 also changes in synchronization therewith. The virtual camera 1 can also move in the virtual space 2 in synchronization with the movement of the user wearing the HMD 110 in the real space.

The direction of the virtual camera 1 is determined based on the position and the inclination of the virtual camera 1, and hence a line of sight (reference line of sight 5) serving as a reference when the user visually recognizes the virtual space image 22 is determined based on the direction of the virtual camera 1. The processor 10 of the computer 200 defines a field-of-view region 23 in the virtual space 2 based on the reference line of sight 5. The field-of-view region 23 corresponds to a field of view of the user wearing the HMD 110 in the virtual space 2.

The line-of-sight direction of the user 190 detected by the eye gaze sensor 140 is a direction in the point-of-view coordinate system obtained when the user 190 visually recognizes an object. The uvw visual-field coordinate system of the HMD 110 is equal to the point-of-view coordinate system used when the user 190 visually recognizes the monitor 112. Further, the uvw visual-field coordinate system of the virtual camera 1 is synchronized with the uvw visual-field coordinate system of the HMD 110. Therefore, in the HMD system 100 in at least one aspect, the line-of-sight direction of the user 190 detected by the eye gaze sensor 140 can be regarded as the user's line-of-sight direction in the uvw visual-field coordinate system of the virtual camera 1.

[User Line-of-Sight]

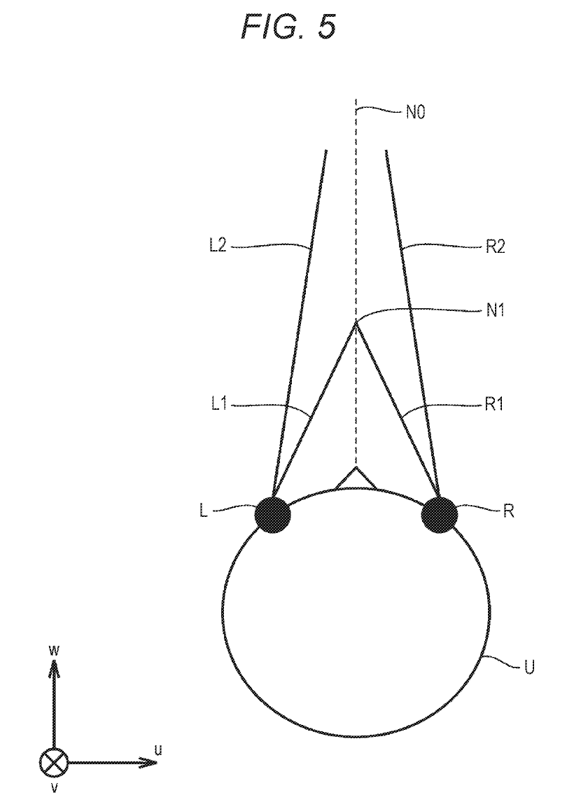

With reference to FIG. 5, determination of the user's line-of-sight direction is described. FIG. 5 is a plan view diagram of the head of the user 190 wearing the HMD 110 of at least one embodiment of this disclosure.

In at least one aspect, the eye gaze sensor 140 detects lines of sight of the right eye and the left eye of the user 190. In at least one aspect, when the user 190 is looking at a near place, the eye gaze sensor 140 detects lines of sight R1 and L1. In another aspect, when the user 190 is looking at a far place, the eye gaze sensor 140 detects lines of sight R2 and L2. In this case, the angles formed by the lines of sight R2 and L2 with respect to the roll direction w are smaller than the angles formed by the lines of sight R1 and L1 with respect to the roll direction w. The eye gaze sensor 140 transmits the detection results to the computer 200.

When the computer 200 receives the detection values of the lines of sight R1 and L1 from the eye gaze sensor 140 as the detection results of the lines of sight, the computer 200 specifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 specifies an intersection of both the lines of sight R2 and L2 as the point of gaze. The computer 200 identifies a line-of-sight direction N0 of the user 190 based on the specified point of gaze N1. The computer 200 detects, for example, an extension direction of a straight line that passes through the point of gaze N1 and a midpoint of a straight line connecting a right eye R and a left eye L of the user 190 to each other as the line-of-sight direction N0. The line-of-sight direction N0 is a direction in which the user 190 actually directs his or her lines of sight with both eyes. Further, the line-of-sight direction N0 corresponds to a direction in which the user 190 actually directs his or her lines of sight with respect to the field-of-view region 23.

In at least one aspect, the HMD system 100 may include microphones and speakers in any part constructing the HMD system 100. When the user speaks to the microphone, an instruction can be given to the virtual space 2 with voice.

Further, in at least one aspect, the HMD system 100 may include a television broadcast reception tuner. With such a configuration, the HMD system 100 can display a television program in the virtual space 2.

In at least one aspect, the HMD system 100 may include a communication circuit for connecting to the Internet or have a verbal communication function for connecting to a telephone line.

[Field-of-View Region]

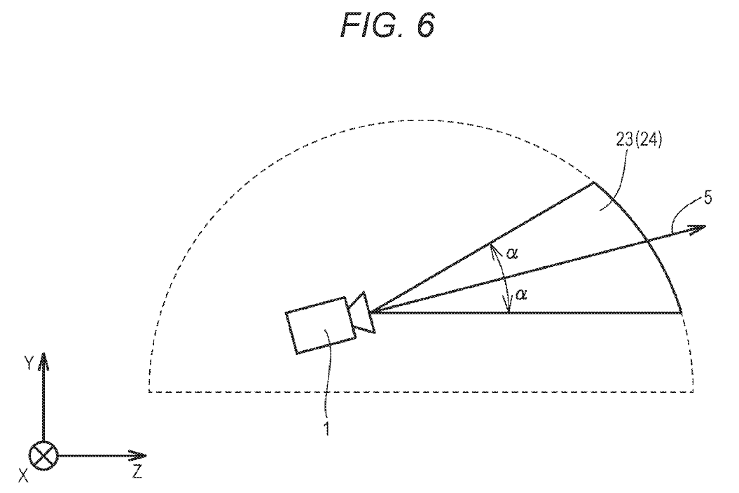

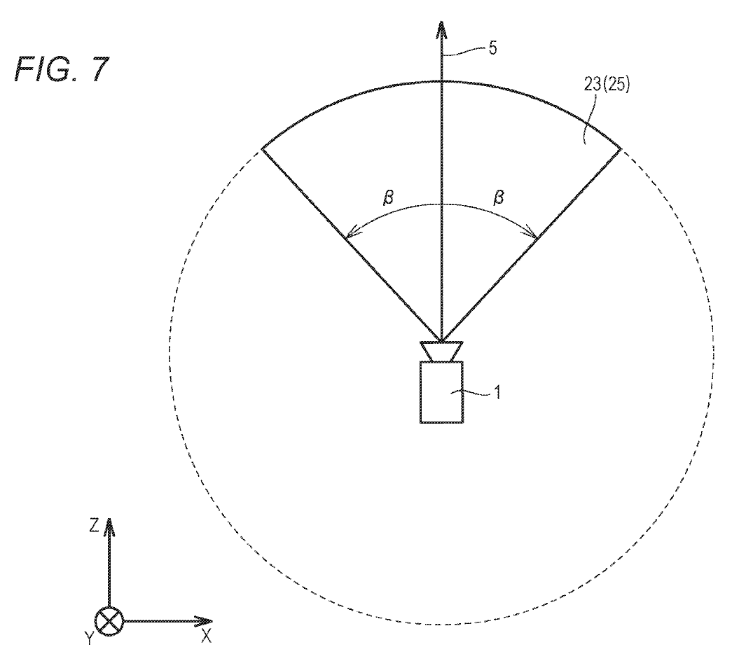

With reference to FIG. 6 and FIG. 7, the field-of-view region 23 is described. FIG. 6 is a diagram of a YZ cross section obtained by viewing the field-of-view region 23 from an X direction in the virtual space 2 according to at least one embodiment of this disclosure. FIG. 7 is a diagram of an XZ cross section obtained by viewing the field-of-view region 23 from a Y direction in the virtual space 2 according to at least one embodiment of this disclosure.

In FIG. 6, the field-of-view region 23 in the YZ cross section includes a region 24. The region 24 is defined by the reference line of sight 5 of the virtual camera 1 and the YZ cross section of the virtual space 2. The processor 10 defines a range of a polar angle α or more from the reference line of sight 5 serving as the center in the virtual space as the region 24.

In FIG. 7, the field-of-view region 23 in the XZ cross section includes a region 25. The region 25 is defined by the reference line of sight 5 and the XZ cross section of the virtual space 2. The processor 10 defines a range of an azimuth β or more from the reference line of sight 5 serving as the center in the virtual space 2 as the region 25.

In at least one aspect, the HMD system 100 causes the monitor 112 to display a field-of-view image based on the signal from the computer 200, to thereby provide the virtual space to the user 190. The field-of-view image corresponds to a part of the virtual space image 22, which is superimposed on the field-of-view region 23. When the user 190 moves the HMD 110 worn on his or her head, the virtual camera 1 is also moved in synchronization with the movement. As a result, the position of the field-of-view region 23 in the virtual space 2 is changed. With this, the field-of-view image displayed on the monitor 112 is updated to an image that is superimposed on the field-of-view region 23 of the virtual space image 22 in a direction in which the user faces in the virtual space 2. The user can visually recognize a desired direction in the virtual space 2.

While the user 190 is wearing the HMD 110, the user 190 cannot visually recognize the real world but can visually recognize only the virtual space image 22 developed in the virtual space 2. Therefore, the HMD system 100 can provide a high sense of immersion in the virtual space 2 to the user.

In at least one aspect, the processor 10 may move the virtual camera 1 in the virtual space 2 in synchronization with the movement in the real space of the user 190 wearing the HMD 110. In this case, the processor 10 specifies an image region to be projected on the monitor 112 of the HMD 110 (that is, the field-of-view region 23 in the virtual space 2) based on the position and the direction of the virtual camera 1 in the virtual space 2.

According to at least one embodiment of this disclosure, the virtual camera 1 is desired to include two virtual cameras, that is, a virtual camera for providing a right-eye image and a virtual camera for providing a left-eye image. Further, in at least one embodiment, an appropriate parallax be set for the two virtual cameras so that the user 190 can recognize the three-dimensional virtual space 2. In at least one embodiment, the virtual camera 1 includes two virtual cameras, and the roll directions of the two virtual cameras are synthesized so that the generated roll direction (w) is adapted to the roll direction (w) of the HMD 110.

[Controller]

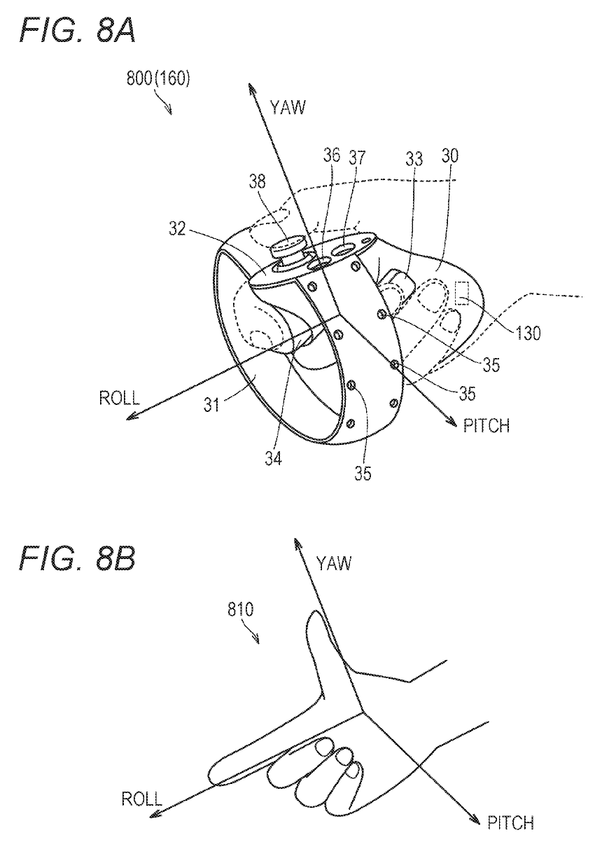

An example of the controller 160 is described with reference to FIGS. 8A and 8B. FIG. 8A is a diagram of a schematic configuration of the controller 160 of at least one embodiment of this disclosure. FIG. 8B is a diagram of a rotational axes of a user's hand in at least one embodiment of this disclosure.

In FIG. 8A, in at least one aspect, the controller 160 may include a controller 800 for the right hand and a controller for the left hand. The controller 800 is operated by the right hand of the user 190. The controller for the left hand is operated by the left hand of the user 190. In at least one aspect, the controller 800 and the controller for the left hand are symmetrically configured as separate devices. Therefore, the user 190 can freely move each of his or her right hand holding the controller 800 and his or her left hand holding the controller for the left hand. In at least one aspect, the controller 160 may be an integrated controller configured to receive an operation by both hands. The controller 800 is now described.

The controller 800 includes a grip 30, a frame 31, and a top surface 32. The grip 30 is configured so as to be held by the right hand of the user 190. For example, the grip 30 may be held by the palm and three fingers (middle finger, ring finger, and small finger) of the right hand of the user 190.

The grip 30 includes buttons 33 and 34, the motion sensor 130, and a battery. The button 33 is arranged on a side surface of the grip 30, and is configured to receive an operation performed by the middle finger of the right hand. The button 34 is arranged on a front surface of the grip 30, and is configured to receive an operation performed by the index finger of the right hand. In at least one aspect, the buttons 33 and 34 are configured as trigger type buttons. The battery 805 and the motion sensor 130 are built into the casing of the grip 30. The battery is configured to supply the power required for the motion sensor 130 and the various circuits to operate. The battery may be a primary battery or a secondary battery. The battery may have an arbitrary shape, for example, a cylindrical shape, a button shape, and a square shape. In at least one embodiment, when a motion of the user 190 can be detected from the surroundings of the user 190 by a camera or other device, the grip 30 does not include the motion sensor 130.

The frame 31 includes a plurality of infrared LEDs 35 arranged in a circumferential direction of the frame 31. The infrared LEDs 35 are configured to emit, during execution of a program using the controller 160, infrared rays in accordance with progress of that program. The infrared rays emitted from the infrared LEDs 35 may be used to detect the position and the posture (inclination and direction) of each of the controller 800 and a controller for a left hand (not shown). In FIGS. 8A and 8B, the infrared LEDs 35 are shown as being arranged in two rows, but the number of arrangement rows is not limited to that in FIGS. 8A and 8B. The infrared LEDs 35 may be arranged in one row or in three or more rows.

The top surface 32 includes buttons 36 and 37 and an analog stick 38. The buttons 36 and 37 are configured as push type buttons. The buttons 36 and 37 are configured to receive an operation performed by the thumb of the right hand of the user 190. The analog stick 38 is configured to receive, in at least one aspect, an operation in an arbitrary direction of 360 degrees from an initial position (neutral position). That operation includes, for example, an operation for moving an object arranged in the virtual space 2.

In FIGS. 8A and 8B, for example, each of the yaw, roll, and pitch directions is defined with respect to a right hand 810 of the user 190. When the user 190 has extended his or her thumb and index finger, the direction in which the thumb is extended is defined as the yaw direction, the direction in which the index finger is extended is defined as the roll direction, and the direction vertical to the plane defined by the axis of the yaw direction and the axis of the roll direction is defined as the pitch direction.

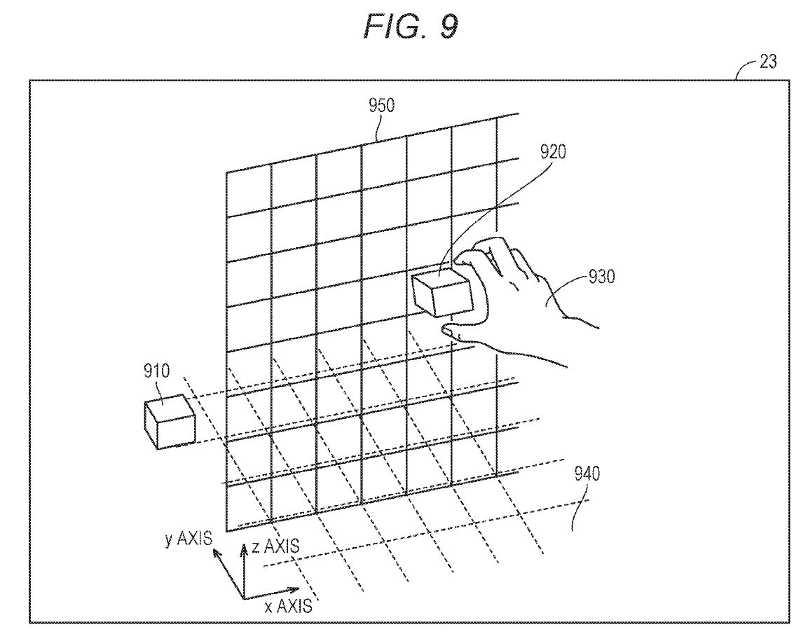

A grid to be arranged in the virtual space 2 is now described with reference to FIG. 9. FIG. 9 is a diagram of a state in which an object is arranged in the field-of-view region 23 of the virtual space 2 according to at least one embodiment of this disclosure.

According to at least one embodiment of this disclosure, an object 910 is arranged in the field-of-view region 23. The object 910 is, for example, a block, a tree, a building, or other object that can be operated in the virtual space 2. A grid 940 is arranged on an x-y plane of the virtual space 2. The object 910 is arranged in a square of the grid 940.

When an operation determined in advance is performed by a hand object 930 corresponding to the right hand of the user 190, an object 920 newly appears in the field-of-view region 23. In the virtual space 2, the user 190 can hold the object 920 by moving the hand object 930. When an operation determined in advance is performed by the hand object 930 in order to arrange a grid 950, a signal in accordance with that operation is transmitted to the computer 200 from the controller 160.

When the processor 10 of the computer 200 detects that the signal has been received, the processor 10 generates a signal for arranging the grid 950 in the virtual space 2, and transmits the generated signal to the HMD 110. The HMD 110 displays an image on the monitor 112 based on that signal. When the user 190 wearing the HMD 110 visually recognizes the image, the user 190 may recognize that the grid 950 is arranged in the virtual space 2.

In at least one aspect, the grid 950 is arranged on a far side of the object 920 that has appeared as an object to be newly arranged. In the field-of-view region 23, a virtual user moves the object 920 and arranges the object 920 at an intended location. The grid 950 is parallel to an x-z plane. In at least one aspect, the grid 950 includes squares defined in advance in accordance with a size of the objects to be arranged in the virtual space 2. For example, when a plurality of objects of different sizes can be arranged in the virtual space 2, the grid 950 having squares in accordance with those objects may be displayed.

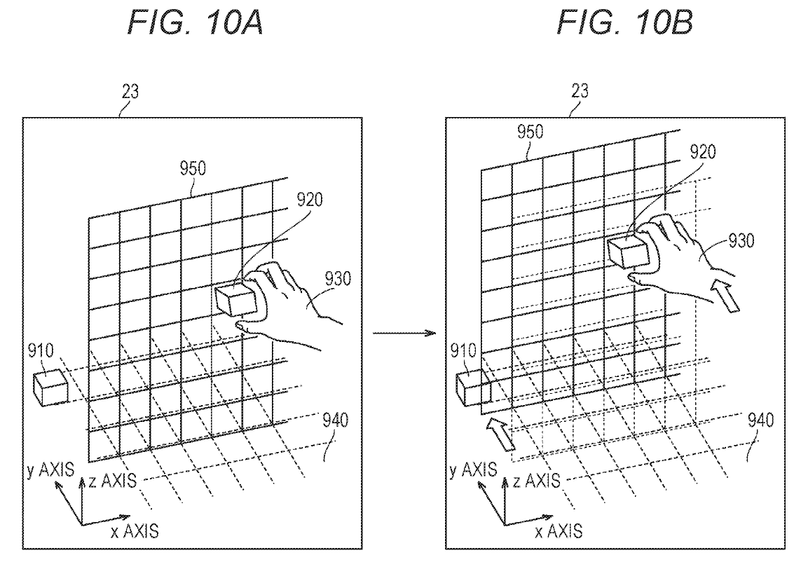

Movement of the grid 950 is now described with reference to FIG. 10. FIGS. 10A and 10B are diagrams for illustrating one mode of movement of the grid 950 arranged in the field-of-view region 23 of the virtual space 2 according to at least one embodiment of this disclosure.

In FIG. 10A, in at least one aspect, the object 920 is newly arranged in the field-of-view region 23. The object 920 is arranged in the field-of-view region 23 when an operation determined in advance has been performed by the hand object 930 based on an actual motion of a hand of the user 190 in the real space, or when a story of the program providing the virtual space 2 has satisfied a condition determined in advance.

When the user 190 moves his or her right hand in the real space, the hand object 930 also moves in accordance with a signal output from the controller 160 that has detected that movement.

For example, the processor 10 detects that the hand object 930 is approaching the object 920 based on the signal output from the controller 160 in accordance with the movement of the hand object 930 and data held by the memory 11 as arrangement information on each object in the field-of-view region 23. When the processor 10 detects that, in the field-of-view region 23, an interval between the hand object 930 and the object 920 is equal to or less than a distance determined in advance, the processor 10 arranges the grid 950 in parallel to the x-z plane. The virtual user recognizing the field-of-view region 23 can move the location of the object 920 in the virtual space 2 by referring to the squares of the grid 950. In at least one embodiment, gravity is not considered in the virtual space 2 unlike in the real space, and hence, in at least one aspect, the virtual user can also arrange the object 920 in mid-air in the virtual space 2 along the squares of the grid 950.

In FIG. 10B, the grid 950 moves in synchronization with the movement of the hand object 930. For example, when the hand object 930 extends in a direction moving away from the virtual user (moving deeper into the field-of-view region 23), the grid 950 also moves in the y-axis direction so as to become more distant from the virtual user. Conversely, when the hand object 930 moves toward the virtual user, the grid 950 also moves so as to become closer to the virtual user.

For example, when the hand object 930 performs in the virtual space 2 an operation determined in advance, the controller 160 detects that operation and transmits a detection signal to the computer 200. When the operation is an operation to turn off the display of the grid 950, the processor 10 of the computer 200 outputs, to the HMD 110, a signal that does not include the image signal output in order to arrange the grid 950 in the virtual space 2. When the monitor 112 displays an image not containing the grid 950 based on that signal, the user 190 may recognize that the display of the grid 950 has been turned off.

[Control Device of HMD]

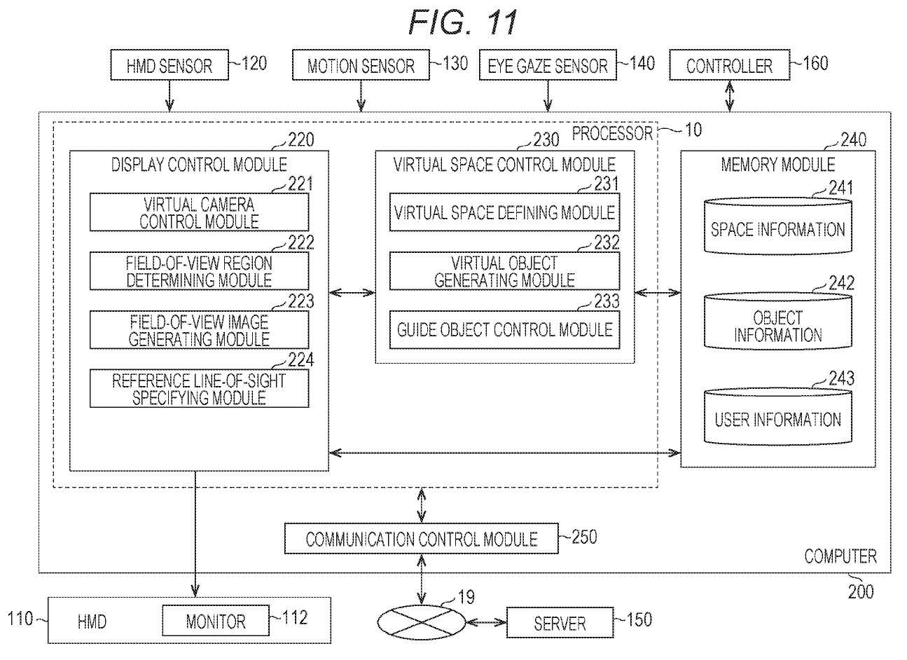

With reference to FIG. 11, the control device of the HMD 110 is described. According to at least one embodiment of this disclosure, the control device is achieved by the computer 200 having a known configuration. FIG. 11 is a block diagram of the computer 200 of at least one embodiment of this disclosure as a module configuration.

In FIG. 11, the computer 200 includes a display control module 220, a virtual space control module 230, a memory module 240, and a communication control module 250. The display control module 220 includes, as sub-modules, a virtual camera control module 221, a field-of-view region determining module 222, a field-of-view image generating module 223, and a reference line-of-sight specifying module 224. The virtual space control module 230 includes, as sub-modules, a virtual space defining module 231, a virtual object generating module 232, and a guide object control module 233.

According to at least one embodiment of this disclosure, the display control module 220 and the virtual space control module 230 are achieved by the processor 10. According to at least one embodiment of this disclosure, a plurality of processors 10 may actuate as the display control module 220 and the virtual space control module 230. The memory module 240 is achieved by the memory 11 or the storage 12. The communication control module 250 is achieved by the communication interface 14.

In at least one aspect, the display control module 220 is configured to control the image display on the monitor 112 of the HMD 110. The virtual camera control module 221 is configured to arrange the virtual camera 1 in the virtual space 2, and control the behavior, the direction, and the like of the virtual camera 1. The field-of-view region determining module 222 is configured to define the field-of-view region 23 in accordance with the direction of the head of the user wearing the HMD 110. The field-of-view image generating module 223 is configured to generate the field-of-view image to be displayed on the monitor 112 based on the determined field-of-view region 23.

The reference line-of-sight specifying module 224 is configured to specify the line of sight of the user 190 based on the signal from the eye gaze sensor 140.

The virtual space control module 230 is configured to control the virtual space 2 to be provided to the user 190. The virtual space defining module 231 is configured to generate virtual space data representing the virtual space 2 to define the virtual space 2 in the HMD system 100.

The virtual object generating module 232 is configured to generate a target to be arranged in the virtual space 2. Examples of the target may include forests, mountains, other landscapes, and animals to be arranged in accordance with the progression of the story of the game.

The guide object control module 233 is configured to arrange a guide object in the virtual space 2. In at least one aspect, the guide object is, for example, arranged in the virtual space 2 as an object having squares like the grids 940 and 950. In at least one aspect, the guide object may be configured not as a grid but as an object having a scale or other type of marking. The guide object is not limited to an object indicating a position based on absolute coordinates like the grids 940 and 950. For example, a grid, a scale, or other guide object using the already-arranged object 910 as an origin may be arranged in the field-of-view region 23.

In at least one aspect, the guide object control module 233 may be configured to change the location of the grid 950 or other guide object in accordance with an operation of the hand object 930 or other operation object in the virtual space 2.

The memory module 240 stores data to be used for providing the virtual space 2 to the user 190 by the computer 200. In at least one aspect, the memory module 240 stores space information 241, object information 242, and user information 243.

The space information 241 stores one or more templates defined for providing the virtual space 2.

The object information 242 stores content to be played in the virtual space 2, an object to be used in that content, and information (e.g., position information) for arranging the object in the virtual space 2. Examples of the content may include a game or content representing a landscape similar to that of the real world.

The user information 243 stores a program for causing the computer 200 to function as the control device of the HMD system 100, an application program that uses each piece of content stored in the object information 242, and the like.

The data and programs stored in the memory module 240 are input by the user of the HMD 110. Alternatively, the processor 10 downloads the programs or data from a computer (e.g., the server 150) that is managed by a business operator providing the content, to thereby store the downloaded programs or data in the memory module 240.

The communication control module 250 may communicate to/from the server 150 or other information communication devices via the network 19.

In at least one aspect, the display control module 220 and the virtual space control module 230 may be achieved with use of, for example, Unity® provided by Unity Technologies. In at least one aspect, the display control module 220 and the virtual space control module 230 may also be achieved by combining the circuit elements for achieving each step of processing.

The processing in the computer 200 is achieved by hardware and software executed by the processor 10. The software may be stored in advance on a hard disk or other memory module 240. The software may also be stored on a compact disc read-only memory (CD-ROM) or other computer-readable non-volatile data recording medium, and distributed as a program product. The software may also be provided as a program product that can be downloaded by an information provider connected to the Internet or other network. Such software is read from the data recording medium by an optical disc drive device or other data reading device, or is downloaded from the server 150 or other computer via the communication control module 250 and then temporarily stored in a storage module. The software is read from the storage module by the processor 10, and is stored in a RAM in a format of an executable program. The processor 10 is configured to execute that program.

The hardware constructing the computer 200 illustrated in FIG. 11 is common hardware. Therefore, apart of at least one embodiment can be said to be the program stored in the computer 200. The operations of the hardware of the computer 200 are known, and hence a detailed description thereof is omitted here.

The data recording medium is not limited to a CD-ROM, a flexible disk (FD), and a hard disk. The data recording medium may also be a non-volatile data recording medium configured to store a program in a fixed manner, for example, a magnetic tape, a cassette tape, an optical disc (magnetic optical (MO) disc, mini disc (MD), or digital versatile disc (DVD)), an integrated circuit (IC) card (including a memory card), an optical card, and semiconductor memories such as a mask ROM, an electronically programmable read-only memory (EPROM), an electronically erasable programmable read-only memory (EEPROM), and a flash ROM.

The term “program” referred to herein does not only include a program that can be directly executed by the processor 10. The program may also include a program in a source program format, a compressed program, or an encrypted program, for example.

[Control Structure]

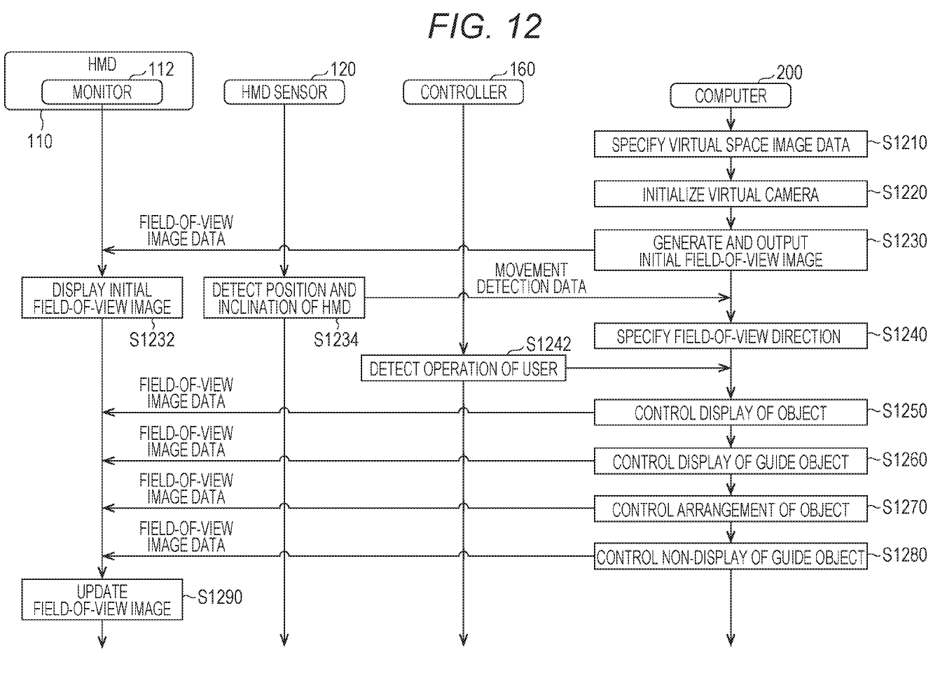

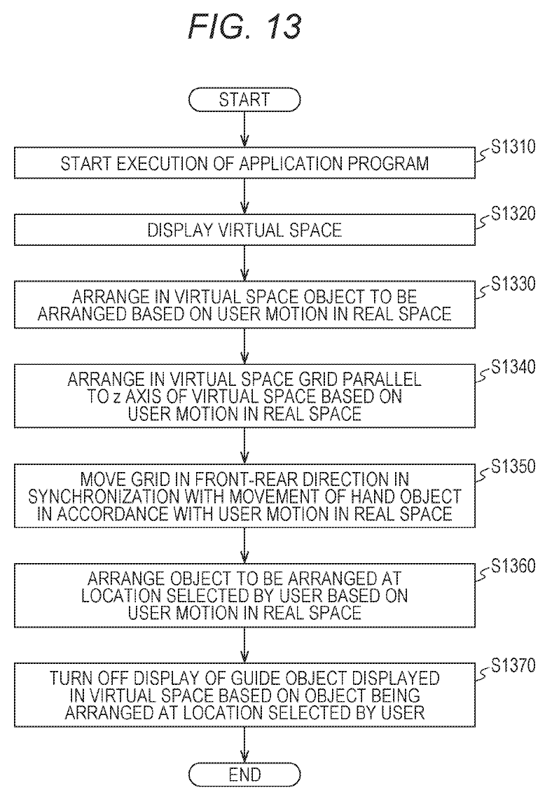

The control structure of the computer 200 of at least one embodiment is now described with reference to FIG. 12 and FIG. 13. FIG. 12 is a flowchart of processing to be executed by the HMD system 100 according to at least one embodiment of this disclosure. FIG. 13 is a flowchart of processing to be executed by the processor 10 of the computer 200 according to at least one embodiment of this disclosure.

With reference to FIG. 12, in Step S1210, the processor 10 of the computer 200 serves as the virtual space defining module 231 to specify the virtual space image data and define the virtual space.

In Step S1220, the processor 10 initializes the virtual camera 1. For example, in a work area of the memory, the processor 10 arranges the virtual camera 1 at the center point defined in advance in the virtual space 2, and directs the line of sight of the virtual camera 1 to a direction in which the user 190 faces.

In Step S1230, the processor 10 serves as the field-of-view image generating module 223 to generate field-of-view image data for displaying an initial field-of-view image. The generated field-of-view image data is transmitted to the HMD 110 by the communication control module 250 via the field-of-view image generating module 223.

In Step S1232, the monitor 112 of the HMD 110 displays the field-of-view image based on the signal received from the computer 200. The user 190 wearing the HMD 110 may recognize the virtual space 2 through visual recognition of the field-of-view image.

In Step S1234, the HMD sensor 120 detects the position and the inclination of the HMD 110 based on a plurality of infrared beams emitted from the HMD 110. The detection result is transmitted to the computer 200 as movement detection data.

In Step S1240, the processor 10 specifies the field-of-view direction of the user 190 wearing the HMD 110 based on the position and the inclination of the HMD 110. The processor 10 executes an application program to arrange an object in the virtual space 2 based on the command included in the application program.

In Step S1242, the controller 160 detects an operation performed by the user 190 in the real space. For example, in at least one aspect, the controller 800, which is an example of the controller 160, detects that the button 36 or 37, or the analog stick 38, has been pressed by the user 190. A signal representing the details of detection is transmitted to the computer 200.

In Step S1250, the processor 10 executes display control of an object in the virtual space 2. For example, the processor 10 generates field-of-view image data for arranging the object 910 in the field-of-view region 23, and transmits that field-of-view image data to the HMD 110. When the monitor 112 of the HMD 110 displays an image based on the generated field-of-view image data (Step S1290), the user 190 may recognize that the object has been arranged in the field-of-view region 23.

In Step S1260, the processor 10 executes guide object display control. For example, the processor 10 generates field-of-view image data for arranging the grids 940 and 950 in the field-of-view region 23, and transmits that field-of-view image data to the HMD 110. When the monitor 112 of the HMD 110 displays an image based on the generated field-of-view image data (Step S1290), the user 190 may recognize that the grids 940 and 950 have been arranged in the field-of-view region 23.

In Step S1270, the processor 10 executes object arrangement control. For example, the processor 10 may change the position of the objects 910 and 920 arranged in the field-of-view region 23 in accordance with a motion of the controller 160 by the user 190. For example, when an operation for arranging the object 920 in an arbitrary square of the grid 950 is performed by the hand object 930 of the virtual user, the object 920 is arranged in that square. When the location in which the objects 910 and 920 are arranged has changed, the processor generates field-of-view image data for arranging the objects 910 and 920 at the changed location, and transmits that field-of-view image data to the HMD 110. When the monitor 112 of the HMD 110 displays an image based on the generated field-of-view image data (Step S1290), the user 190 may recognize that the arrangement of the objects 910 and 920 has changed.

In Step S1280, the processor 10 executes guide object display turn-off control. For example, when the operation for arranging the object 920 at the location desired by the user 190 is complete, the processor 10 generates field-of-view image data that does not include the grids 940 and 950 arranged in the field-of-view region 23, and transmits that field-of-view image data to the HMD 110. When the monitor 112 of the HMD 110 displays an image based on the generated field-of-view image data (Step S1290), the user 190 may recognize that the grids 940 and 950 have disappeared.

With reference to FIG. 13, in Step S1310, the processor 10 starts execution of an application program stored in the memory 11.

In Step S1320, the processor 10 serves as the virtual space defining module 231 to generate image data for displaying the virtual space 2, and to transmit that image data to the HMD 110. When the monitor 112 displays an image based on the generated image data, the user 190 wearing the HMD 110 may recognize the virtual space 2. The processor 10 may also generate, in accordance with the structure of the application program, data for arranging a background object (e.g., a mountain or other background) to be arranged in the virtual space 2. The computer 200 transmits that data to the HMD 110.

In Step S1330, the processor 10 serves as the virtual object generating module 232 to generate field-of-view image data for arranging in the field-of-view region 23 the objects 910 and 920 to be arranged by the user 190. The computer 200 transmits the generated field-of-view image data to the HMD.

In Step S1340, the processor 10 serves as the guide object control module 233 to generate, based on a motion of the user 190 in the real space, field-of-view image data for arranging in the virtual space 2 the flat grid 950 parallel to the z axis (x-y plane) of the virtual space 2. The processor 10 transmits the generated field-of-view image data to the HMD 110 via the input/output interface 13.

In Step S1350, the processor 10 serves as the guide object control module 233 to generate field-of-view image data for moving the flat grid 950 in a front-rear direction (parallel to y axis) in synchronization with the movement of the hand object 930 moving in accordance with a motion of the user in the real space.

In Step S1360, the processor 10 serves as the virtual object generating module 232 to arrange the object 920 at the location instructed by the hand object 930 based on the motion of the user in the real space. More specifically, the processor 10 detects movement of the controller 800 held by the user 190, and specifies a positional relationship between the object 920 and the grid 950 in the virtual space 2 based on the detection result of the movement of the controller 800 and the data for arranging the grid 950. The processor 10 then generates field-of-view image data for arranging the object 920 in an arbitrary square of the grid 950 based on that positional relationship, and transmits the generated field-of-view image data to the HMD 110.

In Step S1370, the processor 10 serves as the guide object control module 233 to turn off, based on the fact that the object 920 has been arranged at the location selected by the user 190, the display of the guide objects (grids 940 and 950) displayed in the field-of-view region 23.

[Arrangement Modes of Guide Objects]

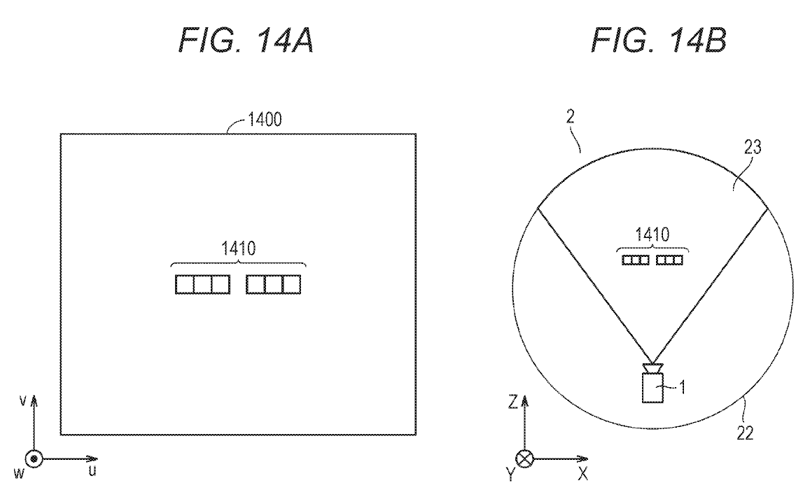

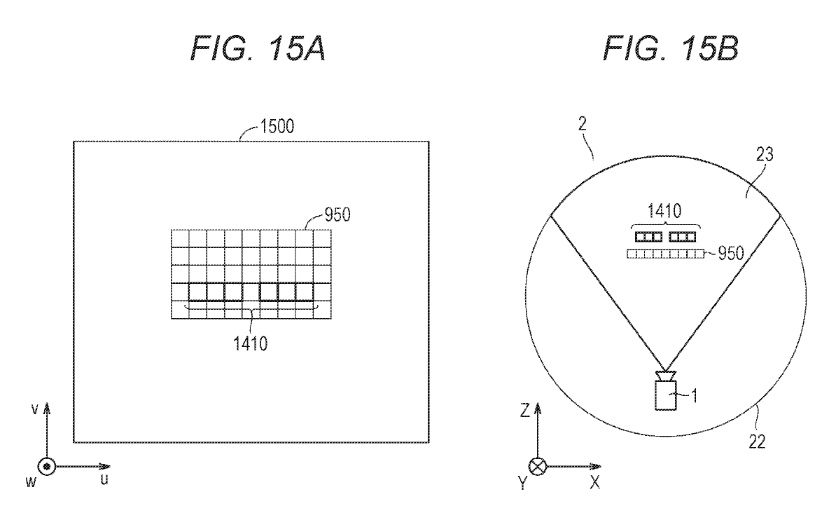

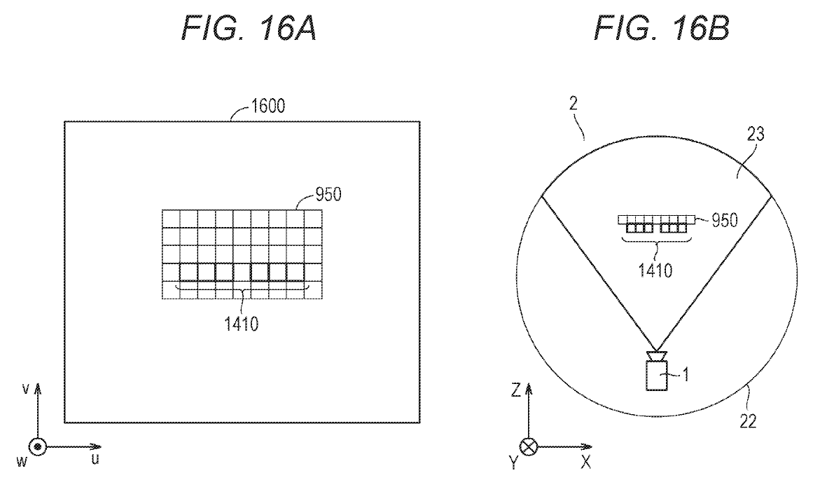

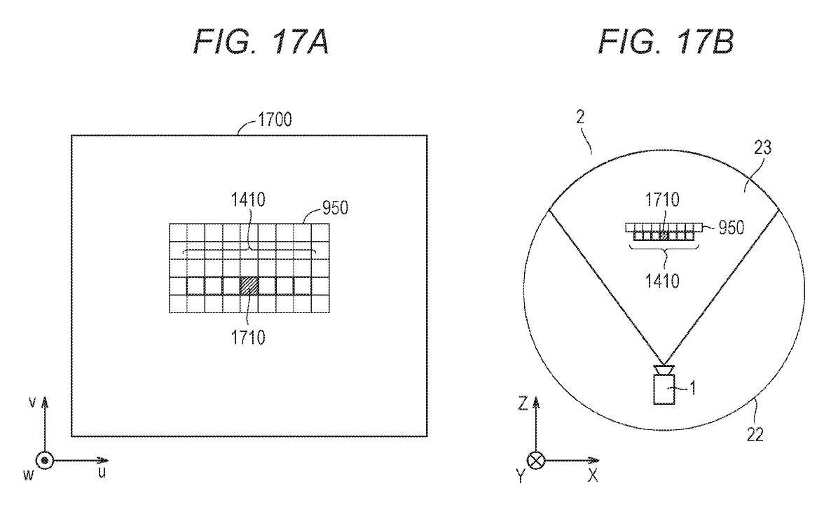

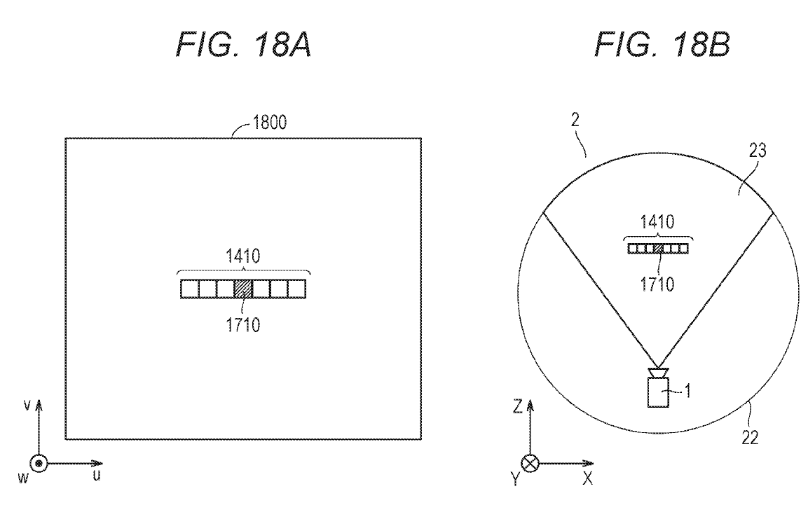

Arrangements of the guide objects in the virtual space 2 are now described with reference to FIG. 14A to FIG. 18B. FIG. 14A to FIG. 18B are each diagrams of a state in which objects 1410 are arranged in the virtual space 2 according to at least one embodiment of this disclosure. More specifically, each of FIG. 14A, FIG. 15A, FIG. 16A, FIG. 17A, and FIG. 18A is a diagram of a field-of-view image that is visually recognized by the user 190 wearing the HMD 110, and each of FIG. 14B, FIG. 15B, FIG. 16B, FIG. 17B, and FIG. 18B is a diagram of the virtual space 2 as seen from above according to at least one embodiment of this disclosure.

In FIG. 14A, in at least one aspect, the user 190 wearing the HMD 110 visually recognizes a field-of-view image 1400. The field-of-view image 1400 includes the objects 1410. In FIG. 14B, the objects 1410 are arranged in a range of the visual field of the virtual camera 1. In this state, when another object is to be arranged, the user who has recognized the field-of-view image 1400 does not possess positioning information for arranging that another object.

With reference to FIGS. 15A and 15B, when the user holding the controller 160 performs an operation determined in advance for arranging a guide object in the virtual space 2, the computer 200 generates field-of-view image data for arranging the guide object, and transmits the generated field-of-view image data to the HMD 110. When the HMD 110 displays the image on the monitor 112 based on the field-of-view image data, the user 190 may recognize the guide object.

For example, in FIG. 15A, the user 190 may visually recognize a field-of-view image 1500. In the field-of-view image 1500, the grid 950 is arranged as a guide object in addition to the objects 1410. The grid 950 is arranged parallel to a u-v plane in accordance with the position of the objects 1410.

In FIG. 15(B), in at least one aspect, the grid 950 may be arranged between the virtual camera 1 and the objects 1410. For example, when the user 190 performs an operation using the controller 160 for causing a new object to appear in the virtual space 2, the grid 950 for assisting with the arrangement of that new object is arranged near the objects 1410.

In at least one mode of the arrangement of the grid 950 is described with reference to FIGS. 16A and 16B. In FIG. 16A, when the objects 1410 and the grid 950 are arranged in the virtual space 2, the user 190 may recognize a field-of-view image 1600 in accordance with that arrangement. Depending on the shape or the color of the objects 1410 or other objects planned to be newly arranged, the grid 950 or other guide objects be arranged behind the objects 1410 as seen from the virtual user, rather than between the objects 1410 and the virtual camera 1 in at least one embodiment. With this configuration, the user 190 can more easily arrange the other objects while looking at the field-of-view image 1600 in FIG. 16A.

The arrangement of the new object is now described in more detail with reference to FIGS. 17A and 17B. In FIG. 17B, in addition to the objects 1410, a new object 1710 to be arranged in the virtual space 2 is also displayed. For example, when the user 190 operates the controller 160, the computer 200 generates, based on that operation, field-of-view image data for arranging the object 1710 in the virtual space 2, and transmits that field-of-view image data to the HMD 110. When the HMD 110 displays an image based on the field-of-view image data on the monitor 112, the user 190 wearing the HMD 110 may recognize a field-of-view image 1700 in which the object 1710 appears.

In FIG. 17B, when the location of the object 1710 has been determined by the virtual user using the hand object while referring to the squares of the grid 950, the object 1710 is arranged in a gap among the objects 1410 that have already been arranged. When arrangement of the new object has ended, the grid 950 or other guide objects are no longer necessary. Therefore, the arrangement of the guide objects ends based on the end of the arrangement of the objects in the virtual space 2.

In at least one aspect, the computer 200 detects, for example, based on an operation by the controller 160, that arrangement of the object 1710 in the virtual space 2 is complete and that there are no further objects to be arranged. In at least one aspect, the computer 200 may determine to end the arrangement of an object in accordance with progress of the program being executed in order to provide the virtual space 2. The computer 200 ends the arrangement of the guide objects in the virtual space 2 when the computer 200 detects that arrangement of an object is no longer being performed. For example, the computer 200 generates field-of-view image data for displaying a field-of-view image that does not include a guide object, and transmits that field-of-view image data to the HMD 110. The HMD 110 displays an image based on that field-of-view image data on the monitor 112. When the user 190 wearing the HMD 110 visually recognizes the image, he or she detects that the display of the grid 950 has disappeared.

For example, in FIG. 18A, a field-of-view image 1800 includes the already-arranged objects 1410 and the newly-arranged object 1710, but does not include the grid 950 that has been arranged until that point.

In FIG. 18B, when the virtual space 2 is seen from above in the x-z plane, the object 1710 is arranged in a gap among the objects 1410.

In a virtual space, the controller is a hand-type model in at least one embodiment, but the actual hand in a real space can be formed into various shapes by changing the shape formed by the fingers. In the real space, a person can communicate with another party by variously changing the shape of his or her hand or by moving his or her hand. For example, a greeting, a welcome, or other intention can be transmitted as a gesture by a person waving his or her hand. However, in the virtual space, reproducing complex shape changes like those of a hand in the real space is difficult. Therefore, there is a need for a technology for promoting communication with another party in the virtual space. In at least one embodiment, there is provided a method for assisting communication in the virtual space.

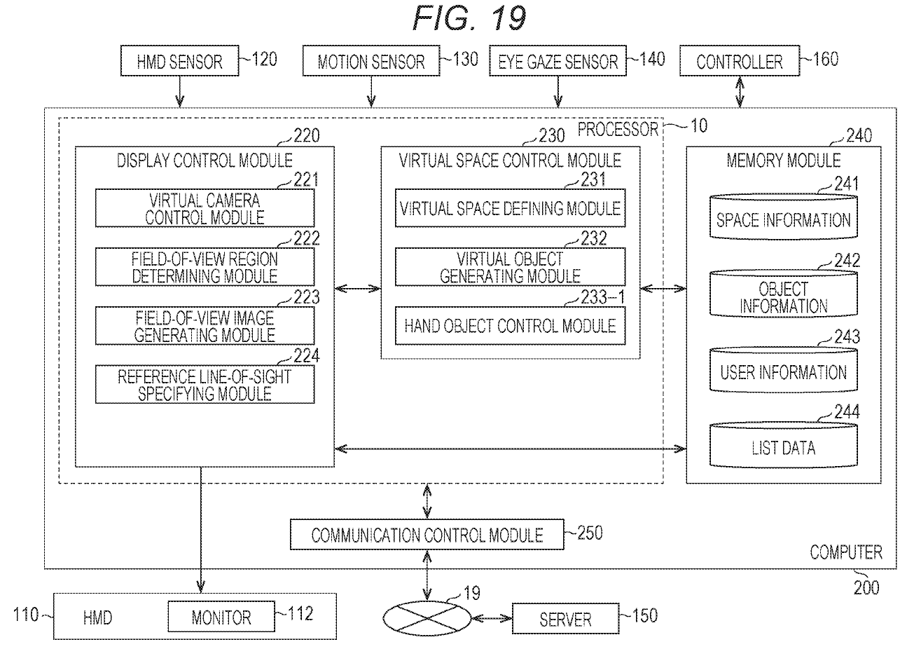

A control device of the HMD 110 is now described with reference to FIG. 19. The control circuit unit 200 in FIG. 19 has a similar configuration to that of the control circuit unit 200 in FIG. 11. However, the configuration of the virtual space control module 230 of the control circuit unit 200 in FIG. 19 is different from that of the control circuit unit 200 in FIG. 11.

The virtual space control module 230 is configured to control the virtual space 2 to be provided to the user 190. The virtual space defining module 231 is configured to generate virtual space data representing the virtual space 2 to define the virtual space 2 in the HMD system 100.

The virtual object generating module 232 is configured to generate a target to be arranged in the virtual space 2. Examples of the target may include forests, mountains, other landscapes, and animals to be arranged in accordance with the progression of the story of the game.

A hand object control module 233-1 is configured to arrange a hand object in the virtual space 2. In at least one aspect, the hand object corresponds to the right hand or the left hand of the user 190 holding the controller 160. In at least one aspect, the hand object control module 233-1 is configured to generate data for arranging the hand object in a mode in which another object appearing in the virtual space 2 is held. In at least one aspect, the hand object control module 233-1 is configured to generate data for arranging the hand object in a mode in which a greeting is given to another user object appearing in the virtual space 2. The mode in which a greeting is given may include, for example, a handshaking motion, a hand waving motion, and the like.

[Control Structure]

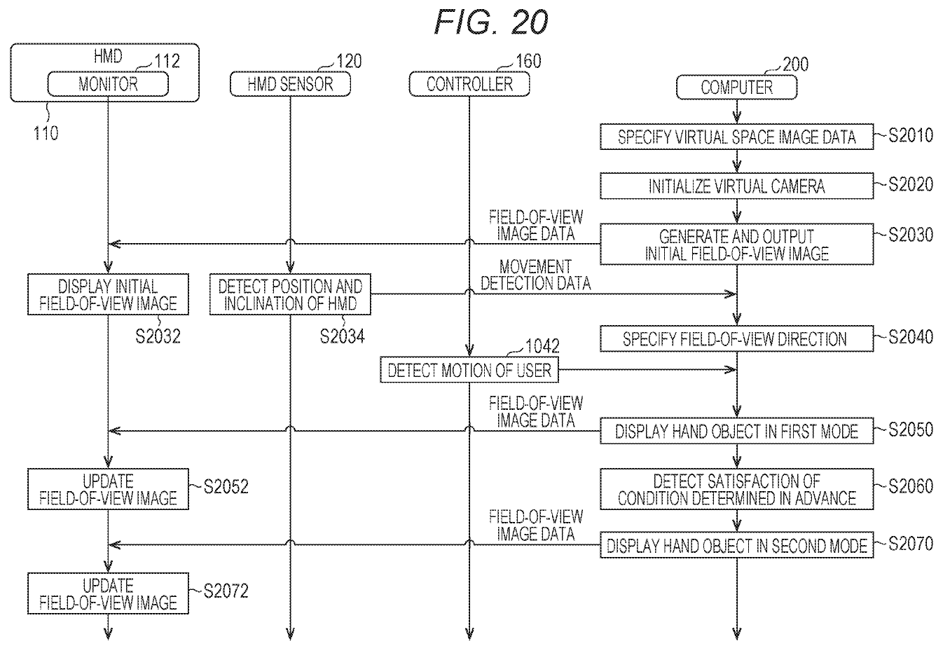

The control structure of the computer 200 of at least one embodiment of this disclosure is now described with reference to FIG. 20. FIG. 20 is a flowchart of processing to be executed by the HMD system 100 according to at least one embodiment of this disclosure.

The control in Steps S2010 to S2042 is the same as that in Steps S1210 to S1242 in FIG. 12.

In Step S2050, the processor 10 generates field-of-view image data for arranging a hand object in the virtual space 2 in a first mode, and transmits the generated field-of-view image data to the HMD 110.

In Step S2052, the HMD 110 updates the field-of-view image based on the received field-of-view image data, and displays the updated field-of-view image on the monitor 112.

In Step S2060, the processor 10 detects, based on movement of the hand of the user 190, that a condition determined in advance as a condition for changing the mode of the hand object has been satisfied.

In Step S2070, the processor 10 generates field-of-view image data for arranging a hand object in the virtual space 2 in a second mode different from the first mode, and transmits the generated field-of-view image data to the HMD 110.

In Step S2072, the HMD 110 updates the field-of-view image based on the received field-of-view image data, and displays the updated field-of-view image on the monitor 112.

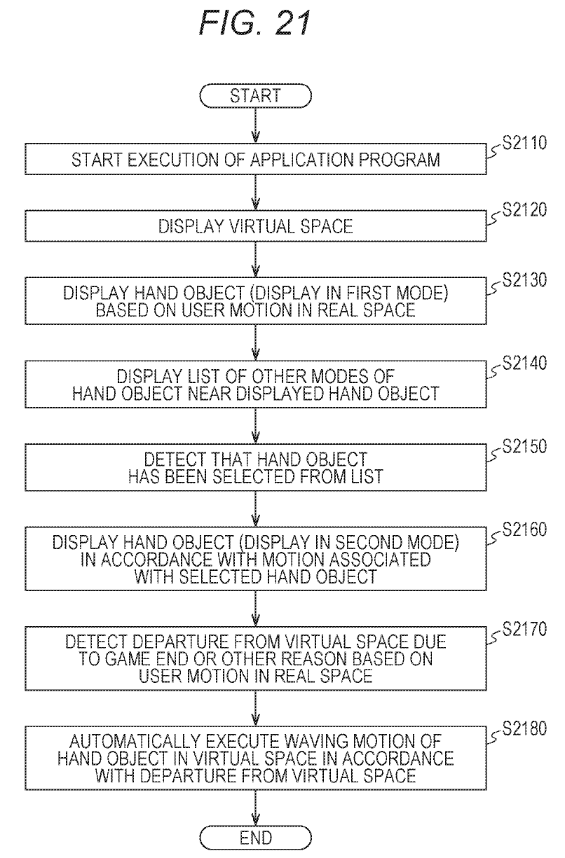

The control structure of the computer 200 of at least one embodiment of this disclosure is now described with reference to FIG. 21. FIG. 21 is a flowchart of processing to be executed by the processor 10 of the computer 200 in at least one aspect of at least one embodiment of this disclosure.

In Step S2110, the processor 10 starts execution of an application program based on an operation of the controller 160 by the user 190.

In Step S2120, the processor 10 serves as the virtual space defining module 231 to define the virtual space 2, and to provide the virtual space 2 to the HMD 110 worn by the user 190 who is holding the controller 160.

In Step S2130, the processor 10 serves as the hand object control module 233-1 to display the hand object in the virtual space 2 in the first mode based on a motion of the user 190 in the real space.

In Step S2140, the processor 10 serves as the hand object control module 233-1 to display near the displayed hand object a list object showing a list of other hand objects shown in a plurality of modes as selectable candidates. When the number of hand objects exceeds the number displayed in the list object region, the processor 10 may arrange the selectable hand objects in the virtual space 2 by scrolling the list object in accordance with an operation of the controller 160 to switch the screen.

In Step S2150, the processor 10 serves as the hand object control module 233-1 to detect that one hand object has been selected from the list object based on the position of the hand object in the virtual space 2 in synchronization with a motion of the user 190 holding the controller 160 and the list of other hand objects shown in a plurality of modes as selectable candidates in the list object.

In Step S2160, the processor 10 serves as the hand object control module 233-1 to arrange, in order to display a hand object in the second mode, that hand object in the virtual space 2 in accordance with a motion associated with the hand object selected in Step S2150.

In Step S2170, the processor 10 detects a departure from the virtual space 2 due to the game end or other reason based on a motion of the user 190 in the real space. Examples of the departure from the virtual space 2 may include the virtual user corresponding to the user 190 performing an operation to log out from the virtual space 2, the disappearance of another virtual user who has appeared in the virtual space 2, a normal shutdown or a forced shutdown of the game or other application program, and the like.

In Step S2180, the processor 10 executes a waving motion of the hand object in the virtual space 2 in accordance with the departure from the virtual space 2.

As at least one mode of the processing, an example has been described in which the computer 200 executes each of the processing steps, but a processor of the HMD 110 may execute some or all of the processing steps.

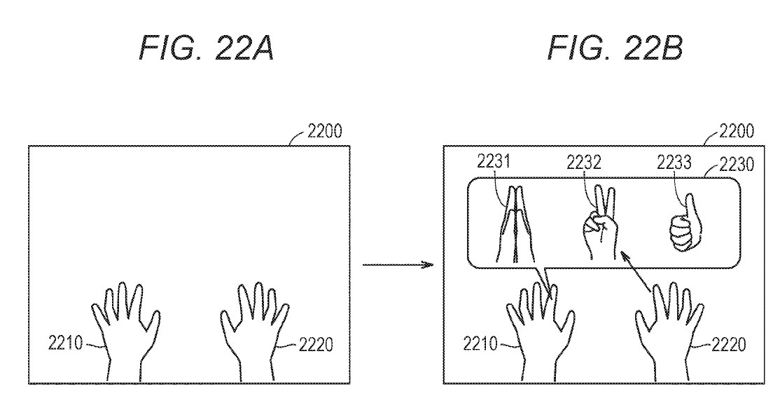

An arrangement of hand objects in the virtual space 2 is now described with reference to FIGS. 22A and 22B. FIGS. 22A and 22B are diagrams of a change in a visual-field image 2200 recognized by the user 190 in the virtual space 2 of at least one embodiment of this disclosure. According to at least one embodiment of this disclosure, hand objects in the shape of a V-sign, hands clasped in prayer, and other special hand shapes are prepared in advance as selection candidates. The shape of the hand objects arranged in the virtual space 2 can be changed by the virtual user corresponding to the user 190 calling selection candidates in the virtual space 2, and selecting any one of the hand objects from the selection candidates as if the hand object were a stamp.

For example, in FIG. 22A, when the user 190 wearing the HMD 110 operates the controller 160, a left-hand object 2210 and a right-hand object 2220 are arranged in the virtual space 2 so as to be recognized as the visual-field image 2200. When the user 190 holding the controller 160 performs an operation for displaying the selection candidates, a list object 2230 is arranged in the virtual space 2.

Specifically, in FIG. 22B, the list object 2230 is arranged near the left-hand object 2210. The list object 2230 includes other hand objects 2231, 2232, and 2233, which are different from the mode (shape) of the left-hand object 2210 and the right-hand object 2220.

In at least one aspect, a mutual interaction is defined in advance for each hand object to be arranged in the virtual space 2. For example, in a case where the list object 2230 includes a two-handed object for clapping, when that two-handed object is selected by the virtual user, a clapping motion is expressed by the left-hand object and the right-hand object of the two-handed object, which collide and separate. When the hands collide, a clapping sound prepared in advance may be output.

In at least one aspect, the left-hand object 2210 and the right-hand object 2220 may be called only when another virtual user (e.g., avatar and another user using the same program) is present in the visual-field image 2200. In this manner, motions considered to be unnatural, for example, clapping when another party is not present, can be prevented.

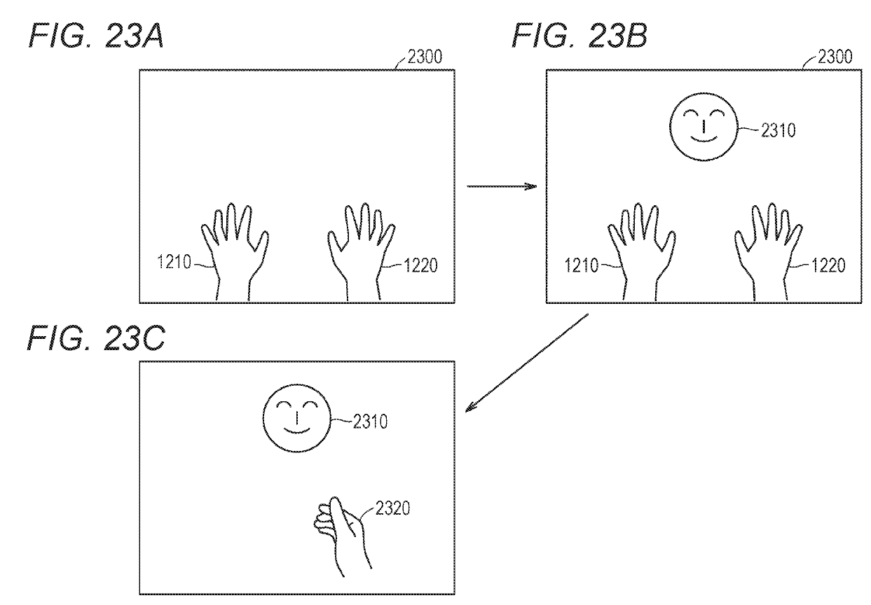

An arrangement of hand objects according to at least one aspect is now described with reference to FIGS. 23A-23C. FIGS. 23A-23C are diagrams of a flow of at least one embodiment of this disclosure until a hand object for shaking hands with another player present in the same virtual space 2 is arranged. In at least one aspect, in the virtual space 2, when the hand object of the user 190 and the hand object of another user are close (e.g., when an interval between the hand objects is equal to or less than a fixed distance set in advance), the hand objects may be changed to a handshake shape or other predetermined shape.

For example, in FIG. 23A, in at least one aspect, hand objects are arranged in the virtual space 2 based on a motion of the user 190. Specifically, a visual-field image 2300 recognized by the virtual user includes the left-hand object 2210 and the right-hand object 2220.

In FIG. 23B, in at least one aspect, another player 2310 is displayed in the visual-field image 2300. For example, the visual-field image 2300 displays, in accordance with progression of the application program (e.g., game) providing the virtual space 2, the other player 2310 when the other player 2310 participates in the virtual space 2. In this case, the user corresponding to the other player 2310 is not required to be present in the real space. In at least one aspect, like in a competitive game or other online game, also when another user present in the real space participates in the virtual space 2 in which the user 190 is present, the visual-field image 2300 may display the other player 2310 corresponding to that another user.

In FIG. 23C, in response to the appearance of the another player 2310, in place of the left-hand object 2210 and the right-hand object 2220 that have been displayed until that point, the visual-field image 2300 displays a right-hand object 2320 for shaking hands.

The trigger causing the right-hand object 2320 to appear in the virtual space 2 may be any of a motion of the user 190 or a motion of the other player. For example, in at least one aspect, the user 190, who has recognized that the other player 2310 has appeared, can cause the right-hand object 2320 to appear in the virtual space 2 by operating the controller 160.

In at least one aspect, when the right-hand object of the other player 2310 has been arranged in the virtual space 2, that arrangement is detected by the processor 10. The processor 10 may also detect that the right-hand object of the other player 2310 has changed to a mode of shaking hands. Therefore, the processor 10 may display the right-hand object 2320 in the visual-field image 2300 in response to the detection of such a change. As a result, the user 190 does not need to perform an operation for calling the right-hand object 2320, and hence the story in the virtual space 2 can progress without missing the handshake timing.

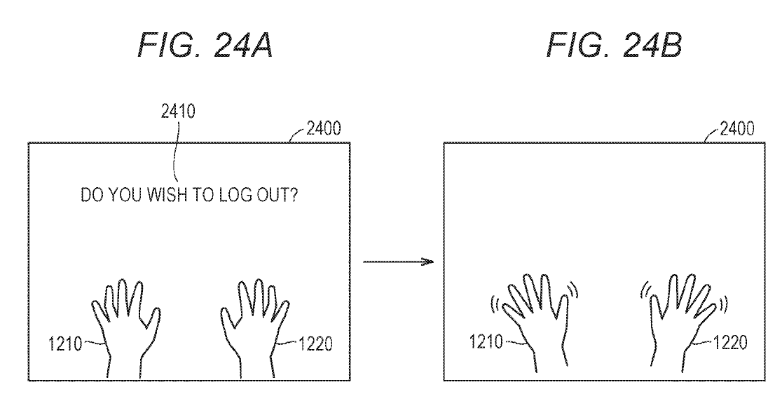

An arrangement of hand objects in at least one aspect is now described with reference to FIGS. 24a and 24B. FIGS. 24A and 24B are diagrams for illustrating a mode of waving hands in the virtual space 2 of at least one embodiment of this disclosure.

In FIG. 24A, in at least one aspect, an application program using the virtual space 2 is executed. At this time, a visual-field image 2400 displays the left-hand object 2210 and the right-hand object 2220 of the virtual user who has appeared based on a motion of the user 190. When the user 190 executes an operation for ending the application program by using the controller 160, a message 2410 for confirming that the application program is to be ended is displayed in the visual-field image 2400.

In FIG. 24B, when the user 190 executes, by operating the controller 160, an operation for confirming that the application program is to be ended, the visual-field image 2400 displays the left-hand object 2210 and the right-hand object 2220 in a waving mode. In this way, the mode and the motion of the hand objects in the virtual space 2 switch, and hence communication in the virtual space 2 is promoted.

The controller in a virtual space is often a hand-type model. However, there are limits on the operation content that can be input by hand gestures. Therefore, there is a need for a technology for achieving more varied input operations. In at least one embodiment, there is provided a method of achieving more varied input operations.

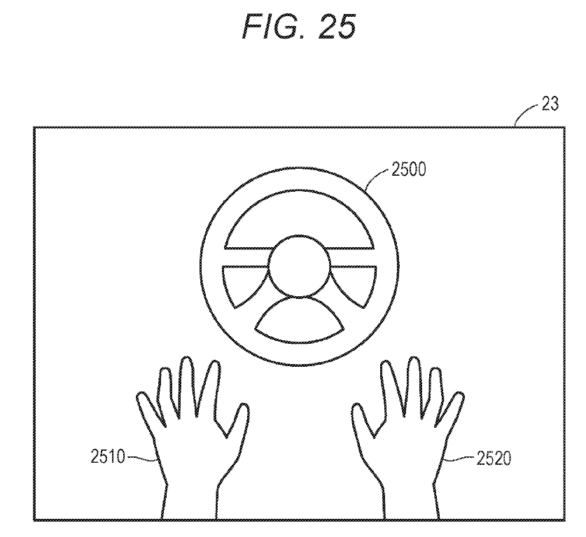

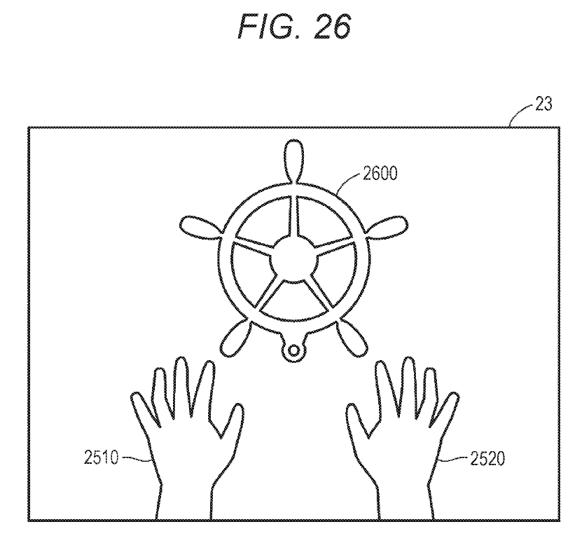

An arrangement of objects in the field-of-view region 23 is now described with reference to FIG. 25 and FIG. 26. FIG. 25 is a diagram of an arrangement of objects in the field-of-view region 23 of at least one embodiment of this disclosure. FIG. 26 is a diagram of an arrangement of objects in the field-of-view region 23 of at least one embodiment of this disclosure.

In FIG. 25, in at least one aspect, the field-of-view region 23 may include a controller object 2500 shaped like a steering wheel, a left-hand object 2510, and a right-hand object 2520. For example, the controller object 2500, which has a rotation axis, is configured to change the position or posture of another object associated with the controller object 2500 in accordance with the rotation direction and rotation speed of the controller object 2500. For example, in a case where the controller object 2500 is associated with a landscape in the virtual space 2, when a motion for causing the steering wheel to rotate in a clockwise direction is performed by the user 190 with both hands, the left-hand object 2510 and the right-hand object 2520 are associated with the controller object 2500, and cause the controller object 2500 to rotate in the clockwise direction. As a result, the direction that the virtual camera 1 is facing also rotates in the clockwise direction, and a landscape that has moved in a right direction by an angle in accordance with the rotation motion performed by the user 190 is displayed in the virtual space 2.

In FIG. 26, in at least one aspect, the field-of-view region 23 may include an object 2600 shaped like a ship's wheel, the left-hand object 2510, and the right-hand object 2520. For example, when the program executed by the computer 200 in order to provide the virtual space 2 shows a sea landscape, the computer 200 may arrange the object 2600 in the virtual space 2 in accordance with a story that progresses in accordance with execution of that program. In this case as well, similar to the case of the controller object 2500 illustrated in FIG. 25, when the left-hand object 2510 and the right-hand object 2520 are associated with the object 2600, the object 2600 can be rotated in accordance with a motion of the user 190, and the image to be displayed as the field-of-view region 23 may change in accordance with the rotation of the object 2600.

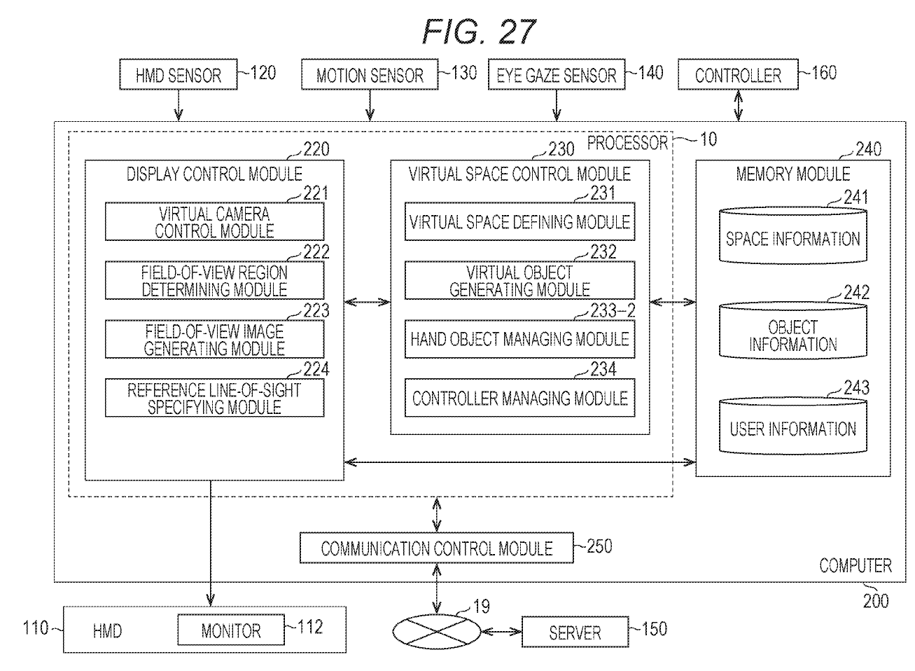

A control device of the HMD 110 is now described with reference to FIG. 27. The control circuit unit 200 in FIG. 27 has a similar configuration to that of the control circuit unit 200 in FIG. 11. However, the configuration of the virtual space control module 230 of the control circuit unit 200 in FIG. 27 is different from that of the control circuit unit 200 in FIG. 11.

The virtual space control module 230 is configured to control the virtual space 2 to be provided to the user 190. The virtual space defining module 231 is configured to generate virtual space data representing the virtual space 2 to define the virtual space 2 in the HMD system 100.

The virtual object generating module 232 is configured to generate a target to be arranged in the virtual space 2. Examples of the target may include forests, mountains, other landscapes, and animals to be arranged in accordance with the progression of the story of the game.

A hand object managing module 233-2 is configured to arrange a hand object in the virtual space 2. For example, the hand object corresponds to the right hand or the left hand of the user 190 holding the controller 160. In at least one aspect, the hand object managing module 233-2 is configured to generate data for arranging the left-hand object 2510 or the right-hand object 2520 in the virtual space 2. In at least one aspect, the hand object managing module 233-2 is configured to generate data representing a motion in which the left-hand object 2510 or the right-hand object 2520 causes another object (e.g., object 2500 or object 2600) to rotate in accordance with the operation of the controller 160 by the user 190. That motion includes, for example, a motion in which the hand holding the steering wheel illustrated as the object 2500 causes the steering wheel to rotate.

[Control Structure]

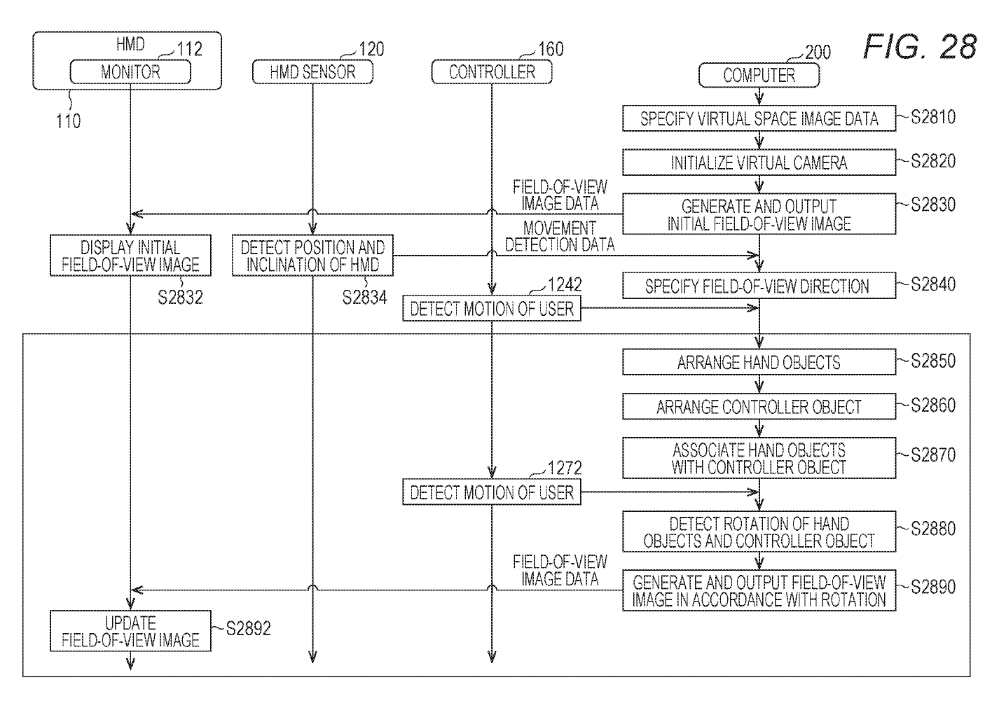

The control structure of the computer 200 of at least one embodiment of this disclosure is now described with reference to FIG. 28. FIG. 28 is a flowchart of processing to be executed by the HMD system 100 according to at least one embodiment of this disclosure.

The control illustrated in Steps S2810 to S2842 is the same as that illustrated in Steps S1210 to S1242 in FIG. 12.

In Step S2850, the processor 10 generates field-of-view image data for arranging a hand object in the virtual space 2, and transmits the generated field-of-view image data to the HMD 110. The HMD 110 displays, when the field-of-view image data is received, the hand object based on the field-of-view image data on the monitor 112.

In Step S2860, the processor 10 generates data for arranging the controller object 2500 or 2600, and transmits the generated field-of-view image data to the HMD 110. The HMD 110 displays, when the field-of-view image data is received, the hand objects based on the field-of-view image data on the monitor 112.

In Step S2870, the processor 10 associates the hand objects (e.g., left-hand object 2510 and right-hand object 2520) with the controller object 2500 or 2600.

In Step S2872, the controller 160 detects a motion of the user 190 based on a signal output from the motion sensor 130. In another aspect, similar to the case of Step S2842, the motion of the user 190 may be detected based on an image from a camera arranged around the user 190.

In Step S2880, the processor 10 detects that the hand objects (e.g., left-hand object 2510 and right-hand object 2520) and the controller object 2500 or 2600 are to be rotated.

In Step S2890, the processor 10 generates field-of-view image data representing that the hand objects (e.g., left-hand object 2510 and right-hand object 2520) and the controller object 2500 or 2600 are being rotated, and transmits the generated field-of-view image data to the HMD 110.

In Step S2892, the HMD 110 updates the field-of-view image based on the received field-of-view image data, and displays the updated field-of-view image on the monitor 112.

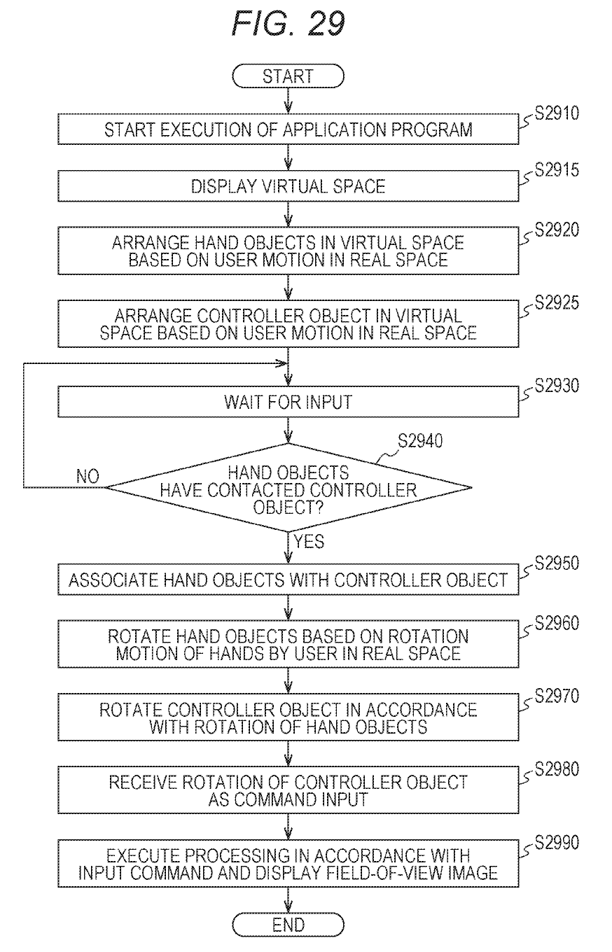

The control structure of the computer 200 of one embodiment of this disclosure is now described with reference to FIG. 29. FIG. 29 is a flowchart of processing to be executed by the processor 10 of the computer 200 in at least one aspect of at least one embodiment of this disclosure.

In Step S2910, the processor 10 starts execution of an application program based on an operation of the controller 160 by the user 190.

In Step S2915, the processor 10 serves as the virtual space defining module 231 to define the virtual space 2, and to provide the virtual space 2 to the HMD 110 worn by the user 190 who is holding the controller 160.

In Step S2920, the processor 10 serves as the hand object managing module 233-2 to arrange the left-hand object 2510 and the right-hand object 2520 in the virtual space 2 based on a motion of the user 190 in the real space.

In Step S2925, the processor 10 serves as a controller managing module 234 to arrange a controller object (e.g., controller object 2500 or controller object 2600) in the virtual space 2 based on a motion of the user 190 in the real space.

In Step S2930, the processor 10 waits for input.

In Step S2940, the processor 10 determines, based on a signal output from the motion sensor 130 and coordinate values of the data for arranging the left-hand object 2510, the right-hand object 2520, and the controller object, whether or not the left-hand object 2510 and the right-hand object 2520 have contacted the controller object. In response to a determination that those objects have contacted the controller object (YES in Step S2940), the processor 10 switches the processing to Step S2950. In response to a determination that those objects have not contacted the controller object (NO in Step S2940), the processor 10 returns the control to Step S2930.

In Step S2950, the processor 10 associates the left-hand object 2510 and the right-hand object 2520 with the controller object. As a result of the association, the controller object may also be moved in accordance with the motion of at least any one of the hand objects.

In Step S2960, the processor 10 causes the left-hand object 2510 and the right-hand object 2520 to rotate based on the rotation motion of the hands of the user 190 in the real space. More specifically, the processor 10 generates field-of-view image data representing that the left-hand object 2510 and the right-hand object 2520 are rotating, and transmits the generated data to the HMD 110. When the monitor 112 displays an image based on that data, the user 190 wearing the HMD 110 may recognize that the left-hand object 2510 and the right-hand object 2520 are rotating in the virtual space 2.

In Step S2970, the processor 10 causes the controller object to rotate in accordance with the rotation of the hand objects in synchronization with the motion of the user 190 in the real space. More specifically, the processor 10 generates, based on a signal from the motion sensor 130 and arrangement information (e.g., coordinate values in the virtual space 2) on the controller object stored as the object information 242, field-of-view image data representing that the controller object 2500 is rotating. When the computer 200 transmits the field-of-view image data to the HMD 110, the monitor 112 displays, based on the field-of-view image data, an image showing that the controller object 2500 is rotating.

In Step S2980, the processor 10 receives, as command input, the rotation of the controller object. More specifically, processing determined in advance in accordance with the level (e.g., rotation angle or rotation speed) of rotation of the controller object is executed in accordance with the rotation.

In Step S2990, the processor 10 executes processing in accordance with the input command, and displays the field-of-view image.

As at least one mode of the processing, an example has been described in which the computer 200 executes each of the processing steps, but a processor of the HMD 110 may execute some or all of the processing steps.

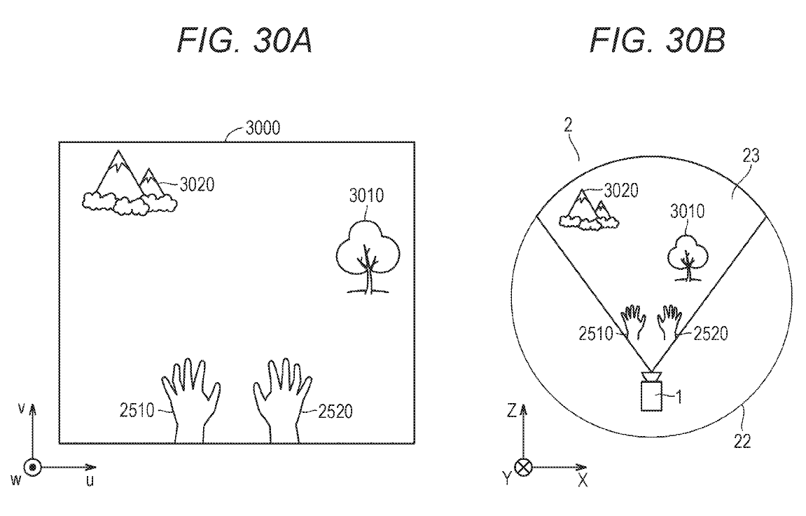

Next, control of another object by the controller object arranged in the virtual space 2 is described with reference to FIG. 30 to FIG. 33. According to at least one embodiment of this disclosure, the user 190 wearing the HMD 110 visually recognizes, as a virtual user, a field-of-view image 3000 in the virtual space 2.

FIGS. 30A and 30B are diagrams of a state in which a controller object is not arranged according to at least one embodiment of this disclosure. In FIG. 30A, the field-of-view image 3000 that is recognized by the virtual user. The field-of-view image 3000 includes the left-hand object 2510, the right-hand object 2520, a tree object 3010, and a mountain object 3020. In FIG. 30A, when the monitor 112 of the HMD 110 displays an image based on the field-of-view image data, the user 190 wearing the HMD recognizes, as the virtual user, the field-of-view image 3000 based on the image displayed by the monitor 112.

FIG. 30B is a diagram of the field-of-view region 23 of the virtual space 2 that results in the field-of-view image 3000. The left-hand object 2510, the right-hand object 2520, the tree object 3010, and the mountain object 3020 are included in a photographing range of the virtual camera 1. The virtual camera 1 corresponding to the point of view of the virtual user photographs the field-of-view region 23 in accordance with the visual field of the virtual user.

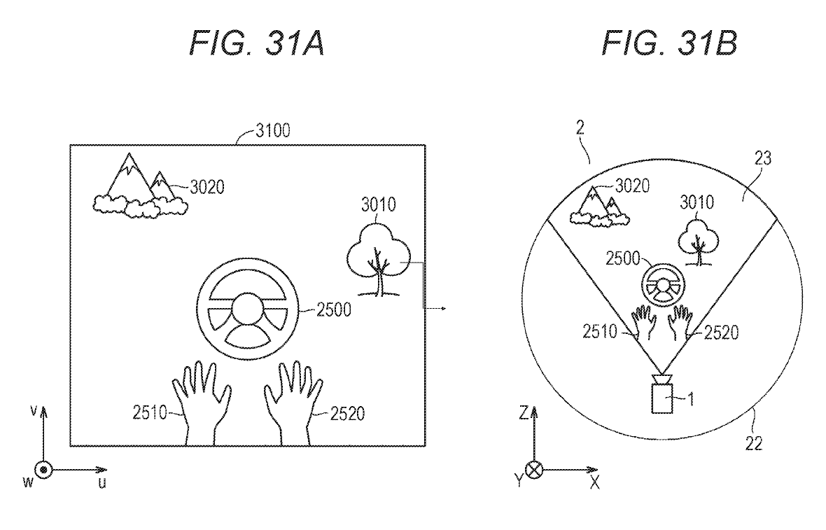

FIGS. 31A and 31B are diagrams of a state in which the controller object 2500 is arranged according to at least one embodiment of this disclosure. When the user 190 executes an operation determined in advance in order to display the controller object 2500, the controller object 2500 is arranged in the virtual space 2.

For example, in FIG. 31A, the controller object 2500 is arranged at a position separated from the left-hand object 2510 and the right-hand object 2520 by a distance determined in advance. At this time, the left-hand object 2510 and the right-hand object 2520 are not associated with the controller object 2500.

In FIG. 31B, the controller object 2500 is arranged in the field-of-view region 23 so as to be separated from the left-hand object 2510 and the right-hand object 2520.

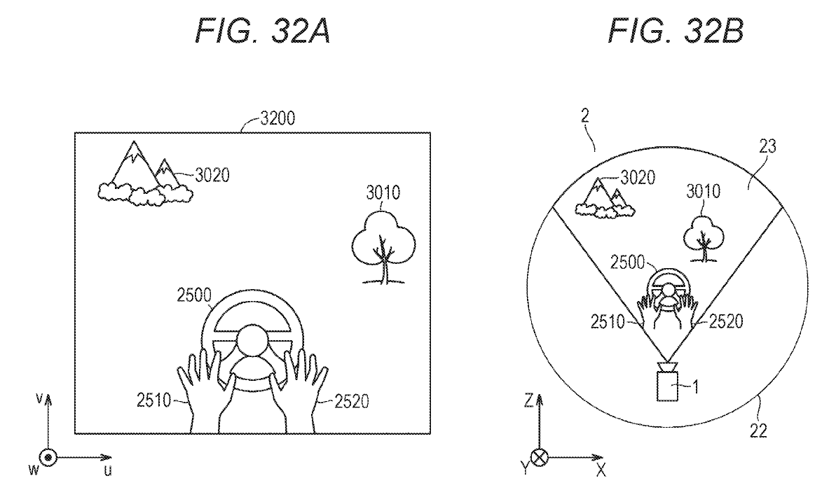

FIGS. 32A and 32B are diagrams of a state in which the left-hand object 2510 and the right-hand object 2520 are associated with the controller object 2500 according to at least one embodiment of this disclosure. When the user 190 executes an operation determined in advance in order to associate the left-hand object 2510 and the right-hand object 2520 with the controller object 2500, the left-hand object 2510 and the right-hand object 2520 each move to a location in contact with the controller object 2500. In at least one aspect, the controller object 2500 may move toward the left-hand object 2510 and the right-hand object 2520.

For example, in FIG. 32A, the left-hand object 2510 and the right-hand object 2520 are in contact with a ring-shaped portion of the controller object 2500. At this time, the left-hand object 2510 and the right-hand object 2520 are associated with the controller object 2500.

In FIG. 32B, the controller object 2500 is arranged in the field-of-view region 23 so as to be in contact with the left-hand object 2510 and the right-hand object 2520.

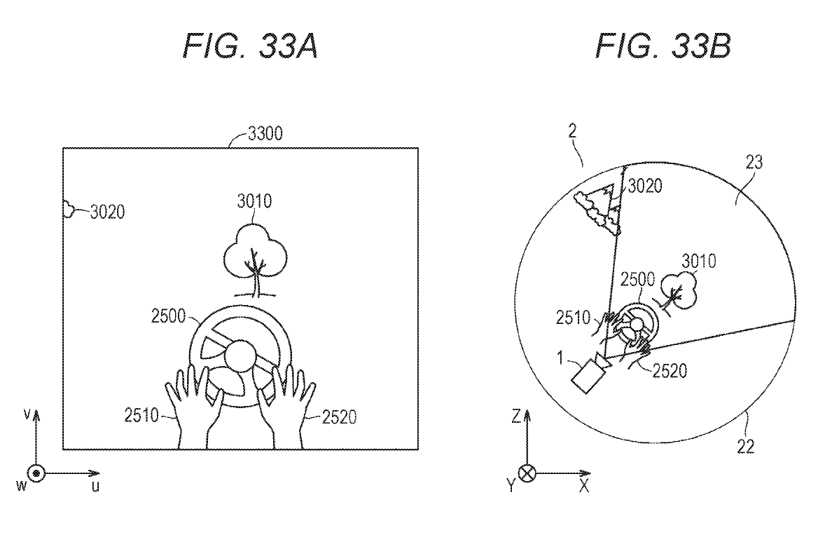

FIGS. 33A and 33B are diagrams of a state in which the left-hand object 2510 and the right-hand object 2520 have operated the controller object 2500 to rotate the controller object 2500 in a right direction according to at least one embodiment of this disclosure. When the user 190 moves his or her left hand and right hand in the real space, in accordance with those movements, the left-hand object 2510 and the right-hand object 2520 move the controller object 2500. For example, when the user 190 performs an operation for turning the steering wheel of a vehicle in the clockwise direction, the left-hand object 2510 and the right-hand object 2520 start to cause the controller object 2500 to rotate in the clockwise direction. At this time, the rotation of the controller object 2500 is interpreted by the processor 10 as a rotation command with respect to the virtual space 2. In response, the processor 10 rotates the virtual camera 1 and creates a field-of-view image of a state in which the line of sight of the virtual user has been moved.

For example, in FIG. 33A, the controller object 2500 rotates in the clockwise direction. As a result of this rotation, a command for changing the line of sight of the virtual user in the virtual space 2 is transmitted to the computer 200.

At this time, in FIG. 33B, the state in which the tree object 3010 is positioned in front is defined by the processor 10 as the field-of-view region 23.

As described in Patent Document 2, when a battery mark indicating the remaining power of a battery is displayed on a head-mounted display, the user may be conscious of the battery mark, and not become fully immersed in the virtual space. In at least one embodiment, there is provided a technology for increasing, when a virtual space is provided, the sense of immersion of the user in the virtual space.

[Control Device of HMD]

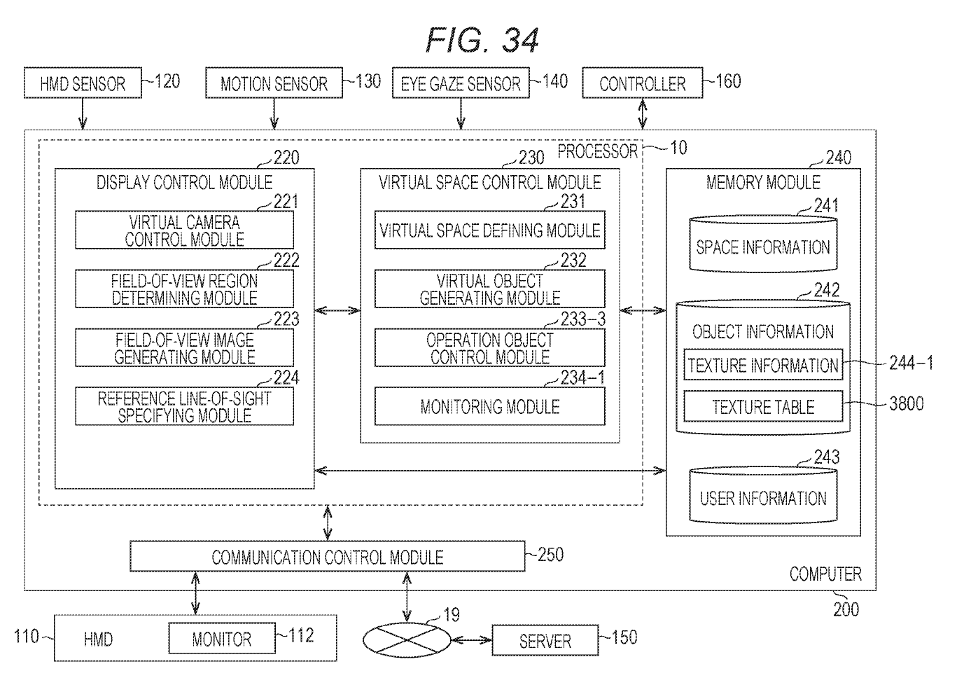

A control device of the HMD 110 is now described with reference to FIG. 34. The control circuit unit 200 in FIG. 34 has a similar configuration to that of the control circuit unit 200 in FIG. 11. However, the configuration of the virtual space control module 230 and the memory module 240 of the control circuit unit 200 in FIG. 34 is different from that of the control circuit unit 200 in FIG. 11.

The virtual space control module 230 is configured to control the virtual space 2 to be provided to the user 190.

An operation object control module 233-3 is configured to arrange in the virtual space 2 an operation object for receiving an operation performed by the user 190 in the virtual space 2. The user 190 operates, for example, an object to be arranged in the virtual space 2 by operating the operation object. In at least one aspect, examples of the operation object may include a hand object corresponding to a hand of the user 190 wearing the HMD 110, a leg object corresponding to a leg of the user 190, a finger object corresponding to a finger of the user 190, and a stick object corresponding to a stick to be used by the user 190. When the operation object is a finger object, in particular, the operation object corresponds to a portion of an axis in the direction (axial direction) indicated by that finger.

A monitoring module 234-1 is configured to monitor a monitoring target in a program executed by the HMD system 100 or the processor 10, and to output changes in the monitoring target to the operation object control module 233-3. An example of the monitoring target is a remaining power of the battery 805 of the controller 800.

The operation object control module 233-3 is configured to change the display mode of the operation object in accordance with the change in the monitoring target input from the monitoring module 234-1. As an example, the operation object control module 233-3 is configured to change the display mode of the operation object by performing processing of pasting a texture on the operation object in accordance with the change in the monitoring target.

When each of the objects arranged in the virtual space 2 has collided with another object, the virtual space control module 230 detects that collision. The virtual space control module 230 can detect, for example, the timing of a given object touching another object, and when that detection has occurred, performs processing determined in advance. The virtual space control module 230 can detect the timing at which objects that are touching separate from each other, and when that detection has occurred, performs processing determined in advance. The virtual space control module 230 can also detect a state in which objects are touching. Specifically, the operation object control module 233-3 detects, when the operation object and another object come into contact to each other, that the operation object and the another object have touched, and performs processing determined in advance.

The memory module 240 stores data to be used for providing the virtual space 2 to the user 190 by the computer 200.

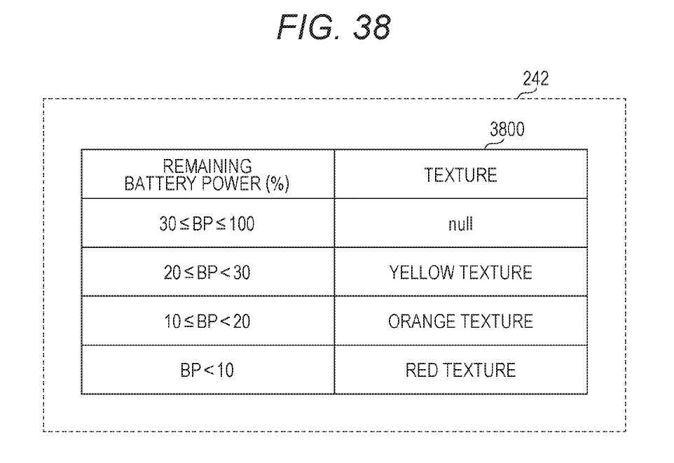

The object information 242 stores content to be played in the virtual space 2, an object to be used in that content, and information (e.g., position information) for arranging the object in the virtual space 2. Examples of the content may include a game and content representing a landscape similar to that of the real world. The object information 242 further includes texture information 244-1 and a texture table 3800. The texture information 244-1 stores a texture to be pasted on the object. The texture table 3800 stores a condition for pasting a texture on the object. The texture table 3800 is described in more detail later with reference to FIG. 38.

[Control Structure]

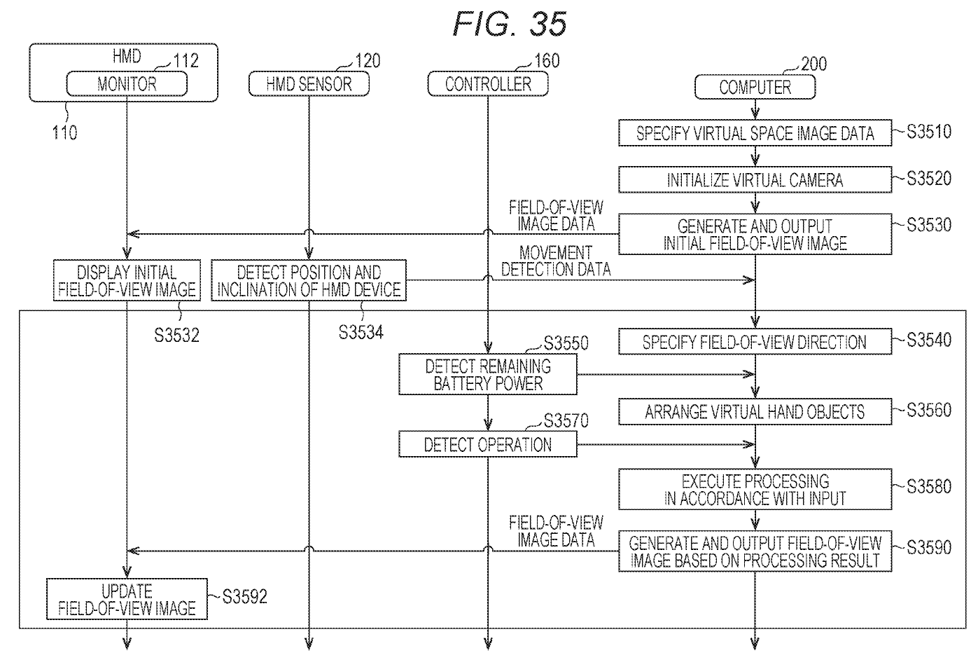

The control structure of the computer 200 of at least one embodiment of this disclosure is now described with reference to FIG. 35 to FIG. 37B. FIG. 35 is a flowchart of processing to be executed by the HMD system 100 according to at least one embodiment of this disclosure.

With reference to FIG. 35, the control in Steps S3510 to S3534 is the same as that in Steps S1210 to S1234 in FIG. 12.

In Step S3540, the processor 10 specifies the field-of-view direction of the user 190 wearing the HMD 110 based on the position and the inclination of the HMD 110. The processor 10 also serves as the virtual object generating module 232 to arrange an object in the virtual space 2.

In Step S3550, the controller 160 detects the remaining battery power of the controller 160. The controller 160 generates instructions for transmitting data representing the detected remaining battery power to the computer 200. In at least one aspect, the controller 160 is achieved by the controller 800 for the right hand and the controller for the left hand. In this case, the controller 800 detects the remaining power (e.g., a voltage value) of the battery 805 by using a tester (not shown), and transmits the detection result to the computer 200. The controller for the left hand also performs a similar operation to that of the controller 800 for the right hand.

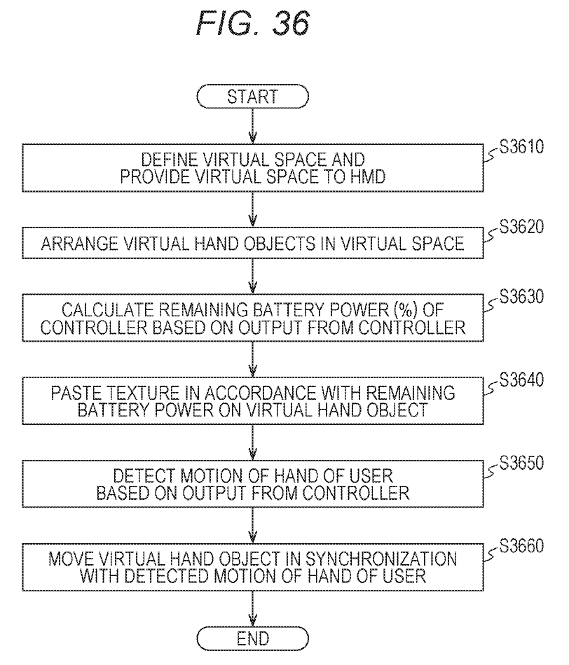

In Step S3560, the processor 10 serves as the operation object control module 233-3 to arrange virtual hand objects in the virtual space. The virtual hand objects correspond to the hands of the user 190 in the real space. At this time, the processor 10 determines the display mode of the virtual hand objects based on the remaining battery power input from the controller 160. This control is described in more detail later with reference to FIG. 36.

In Step S3570, the controller 160 detects an operation performed by the user 190 in the real space. For example, in at least one aspect, the controller 160 detects the fact that a button has been pressed by the user 190. In at least one aspect, the controller 160 detects a motion of both hands (e.g., waving both hands) of the user 190. A detection signal representing the detection content is transmitted to the computer 200.

In Step S3580, the processor 10 serves as the operation object control module 233-3 to control (process) a motion of the virtual hand objects based on the detection signal input from the controller 160.

In Step S3590, the processor 10 serves as the field-of-view image generating module 223 to generate field-of-view image data for displaying the field-of-view image based on the processing result, and to output the generated field-of-view image data to the HMD 110.

In Step S3592, the monitor 112 of the HMD 110 updates the field-of-view image based on the received field-of-view image data, and displays the updated field-of-view image.

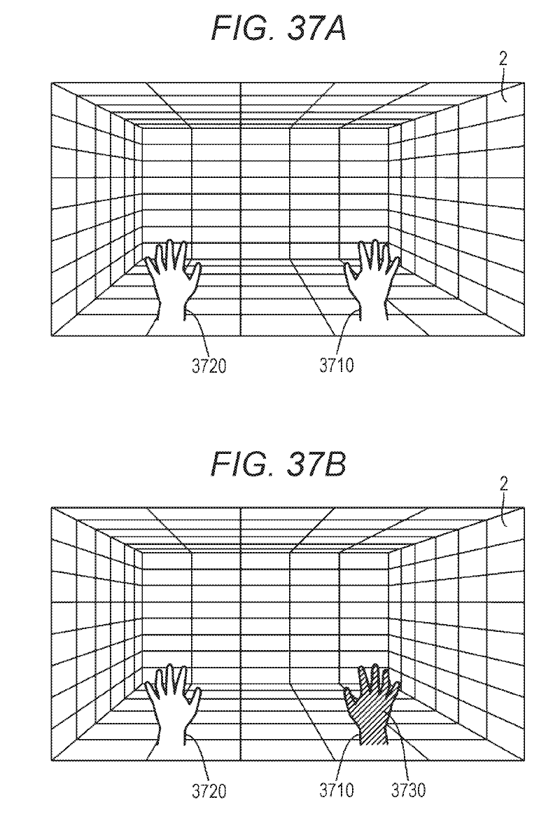

Next, display control of the virtual hand objects as operation objects is described with reference to FIG. 36 and FIG. 37B. FIG. 36 is a flowchart of control of the virtual hand objects to be executed by the processor 10 of the computer 200 according to at least one embodiment of this disclosure. FIGS. 37A and 37B are diagrams of a part of the processing in FIG. 36 according to at least one embodiment of this disclosure. In the processing in FIG. 36, the user 190 uses the controller 800 for the right hand and the controller for the left hand as the controller 160. The control of the virtual hand object for the right hand corresponding to the controller 800 for the right hand and the control of the virtual hand object for the left hand corresponding to the controller for the left hand are the same processing, and hence control of the virtual hand object for the right hand is described below.

In Step S3610, the processor 10 serves as the virtual space defining module 231 to define the virtual space 2, and to provide the virtual space 2 to the HMD 110 worn by the user 190 who is holding the controller 160.

In Step S3620, the processor 10 arranges, as in FIG. 37A, a virtual hand object 3710 for the right hand and a virtual hand object 3720 for the left hand in the defined virtual space 2.

In Step S3630, the processor 10 serves as the monitoring module 234-1 to calculate the remaining battery power of the controller 160 based on output from the controller 160. As an example, the controller 800 for the right hand outputs a voltage value of the battery 805 to the computer 200. The processor 10 may calculate, based on the ratio of the operating voltage of the controller 800 stored in advance in the memory module 240 relative to the voltage value of the battery 805, a remaining power BP of the battery 805 indicated as a percentage.

In Step S3640, the processor 10 serves as the operation object control module 233-3 to refer to the texture table 3800, and to specify the texture corresponding to the remaining power BP of the battery 805. The processor 10 also acquires the specified texture from the texture information 244-1, and pastes (superimposes) the acquired texture on the virtual hand object.

FIG. 38 is a diagram for showing the texture table 3800 of at least one embodiment of this disclosure. The texture table 3800 stores a range of the remaining power BP of the battery and the texture to be pasted on the virtual hand object, which are associated with each other.

When the remaining power BP of the battery 805 is 30% or more, a texture is not set in the texture table 3800, and hence the processor 10 does not paste a texture on the virtual hand object 3710 for the right hand.

On the other hand, when the remaining power BP of the battery 805 is less than 30%, some kind of texture is set in the texture table 3800, and hence, as in FIG. 37B, the processor 10 pastes a texture 3730 on the virtual hand object 3710 for the right hand. For example, when the remaining power BP of the battery 805 is 20% or more and less than 30%, the processor 10 pastes a yellow texture on the virtual hand object 3710. As a result, the virtual hand object 3710 turns yellow. For example, when the remaining power BP of the battery 805 is less than 10%, the processor 10 pastes a red texture on the virtual hand object 3710. As a result, the virtual hand object 3710 turns red.

Referring again to FIG. 36, in Step S3650, the processor 10 serves as the operation object control module 233-3 to detect a motion of a hand of the user 190 based on the detection signal output from the controller 160 (motion sensor 130).

In Step S3660, the processor 10 serves as the operation object control module 233-3 to move the virtual hand object in synchronization with the detected motion of the hand of the user 190.

In the above description, the HMD system 100 can notify the user 190 of a remaining battery power of the controller 160 by changing the display mode of the virtual hand objects to be displayed in the virtual space, without displaying a graphical user interface (GUI) like a battery mark for indicating the remaining battery power of the controller 160 in the virtual space. As a result, the HMD system 100 may suppress a decrease in the sense of immersion of the user 190 in the virtual space due to the display of an unnatural GUI.

In at least the example described above, there is described a configuration in which the color of the operation object changes in steps in accordance with a range of the remaining battery power. However, in at least one aspect, the color of the operation object may continuously change (e.g., change such that the wavelength gradually lengthens from green to red) in accordance with the remaining battery power.

In at least the example described above, there is described a configuration in which the display mode of the operation object is changed by using the remaining battery power indicated as a percentage. However, in at least one aspect, the display mode of the operation object may be changed by using a measurement value, for example, the voltage value, as is.

[Other Display Modes]

In at least the example described above, the processor is configured to notify the user 190 of the remaining battery power by changing the color of an operation object. Other configurations for changing the display mode of an operation object are now described with reference to FIG. 39 to FIG. 42B. The control of the virtual hand object for the right hand corresponding to the controller 800 for the right hand and the control of the virtual hand object for the left hand corresponding to the controller for the left hand are the same processing, and hence control of the virtual hand object for the right hand is described below.

FIG. 39 is a diagram of a display mode of operation objects of at least one embodiment of this disclosure. In FIG. 39, in at least one embodiment of this disclosure, the processor 10 performs control so that the virtual hand object 3710 for the right hand becomes more transparent as the remaining power BP of the battery 805 decreases to clearly show bones inside the virtual hand object 3710.

For example, the processor 10 arranges, inside the virtual hand object 3710, a bone object in association with that virtual hand object 3710, and increases the transmittance of the virtual hand object 3710 as the remaining power BP of the battery 805 decreases. As a result, as the remaining power BP of the battery 805 decreases, the bone object arranged inside the virtual hand object 3710 is more clearly shown. In at least one aspect, the processor 10 may perform control so as to gradually increase the transmittance of the virtual hand object 3710 from 0% when the remaining power BP of the battery falls below a threshold value (e.g., 30%) determined in advance.

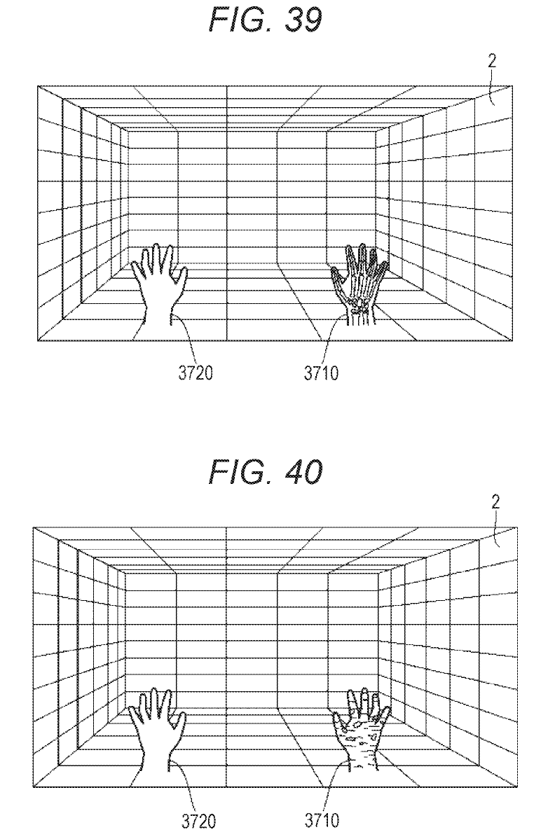

FIG. 40 is a diagram of a display mode of operation objects in at least one aspect. In FIG. 40, the processor 10 performs control so that the virtual hand object 3710 for the right hand becomes more degraded (broken apart) as the remaining power BP of the battery 805 decreases.

For example, similar to the method described with reference to FIG. 38, the processor 10 stores in the texture information 244-1 textures having different degradation levels. The processor 10 pastes, in accordance with the range of the remaining power BP of the battery 805, a texture on the virtual hand object 3710 such that the relevant object looks degraded.

In at least one aspect, the processor 10 may perform control so that an operation object blinks on and off in accordance with the remaining battery power of the controller 160.

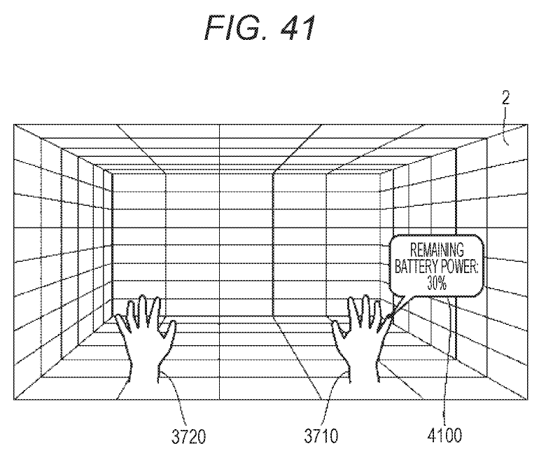

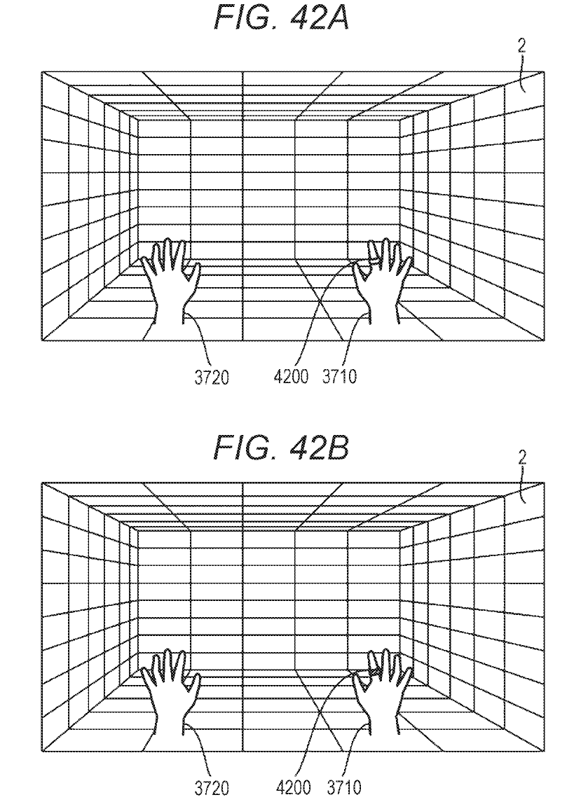

In the examples in FIG. 37, FIG. 39, and FIG. 40, there are described configurations in which the display mode of an operation object (virtual hand object) itself changes. However, instead of changing the display mode of the operation object, the display mode of an object (accompanying object) accompanying the operation object may be changed in at least one embodiment. There are now described, with reference to FIG. 41 and FIGS. 42A and 42B, configurations in which the display mode of an accompanying object is changed.

FIG. 41 is a diagram of a display mode of an accompanying object of at least one embodiment of this disclosure. In FIG. 41, in at least one embodiment, when the remaining power BP of the battery 805 falls below a threshold value determined in advance, the processor 10 arranges a popup object 4100 in the virtual space 2 for notifying the user of that fact. In at least one aspect, the popup object 4100 is arranged near the virtual hand object 3710, and operates in synchronization with the virtual hand object 3710. In other words, the popup object 4100 is an accompanying object accompanying the virtual hand object 3710. The popup object 4100 may be set to disappear after being displayed for a time (e.g., 5 seconds) determined in advance.

FIGS. 42A and 42B are diagrams of a display mode of an accompanying object in at least one aspect. In at least one aspect, in FIG. 42A, the processor 10 arranges in the virtual space 2 a ring object 4200 accompanying the virtual hand object 3710. In FIG. 42B, the processor 10 changes the color of the ring object 4200 when the remaining power BP of the battery 805 falls below a threshold value determined in advance. The control for changing the color of the ring object 4200 may be achieved by using similar processing to the processing described above with reference to FIG. 38.

In the above description, the HMD system 100 of at least one embodiment of this disclosure can notify, without causing the user 190 to feel a sense of strangeness, the user 190 of the remaining battery power (change in monitoring target) by changing the display mode of an accompanying object having a small area in the field-of-view image instead of an operation object having a large area. As a result, the user 190 can become more immersed in the virtual space.

The HMD system 100 can also notify, in FIG. 39 to FIG. 42B, the user 190 of the remaining battery power by changing the display mode of the operation object or the accompanying object accompanying the operation object in accordance with the remaining battery power. As a result of those pieces of control, the HMD system 100 can notify the user 190 of the remaining battery power of the controller 160 by changing the display mode of the objects to be displayed in the virtual space, without displaying a GUI like a battery mark for indicating the remaining battery power of the controller 160 in the virtual space.

[Other Monitoring Targets]

In at least one embodiment described above, the monitoring module 234-1 is configured to monitor the remaining battery power of the controller 160 as the monitoring target, but the monitoring target is not limited thereto.

(Game Playing Time)

For example, the monitoring target may be a playing time of the game provided in the virtual space. The game may be provided by the processor 10 executing a game program stored in the storage 12.

The processor 10 may change the display mode of the operation object or the accompanying object accompanying the operation object when the playing time of the game has exceeded a time determined in advance. The time determined in advance may also be set by the user 190.

(Amount of Money Paid in Game)

For example, the monitoring target may be an amount of money paid by the user in the game provided in the virtual space. In at least one aspect, the user 190 may purchase items and the like in the game by using the currency of the real space. The processor 10 may change, based on log information stored in the memory module 240, the display mode of the operation object or the accompanying object accompanying the operation object when the amount of money paid in the game has exceeded an amount of money determined in advance. The amount of money determined in advance may also be set by the user 190.

(In-Game Parameter)

In at least the examples described above, the monitoring target is an index of the real space. In at least one aspect, the monitoring target may be a parameter in a game provided in the virtual space. The processor 10 may change, when a magnitude relationship between an in-game parameter value and a value determined in advance has reversed, the display mode of the operation object or the accompanying object accompanying the operation object. Examples of the in-game parameter value include an experience value or a stamina value of a character operated by the user 190 in the game, the number of remaining bullets of a gun used by the character, and an (in-game) amount of money possessed by the character.

(Interrupt Communication)

In at least one aspect, the monitoring target may be the presence or absence of communication from another computer via the network 19. In at least one aspect, the game to be provided in the virtual space may be a competitive game or a cooperative game with another user operating another HMD system. In this case, the HMD system 100 can notify the user 190 of the communication from another computer by, without arranging an unnatural GUI indicating that there has been communication from another computer, changing the display mode of an operation object to be displayed in the virtual space. As a result, the HMD system 100 may suppress a decrease in the sense of immersion of the user 190 in the virtual space due to the display of an unnatural GUI.

[Supplementary Note 1]

[Configuration 1]

According to at least one embodiment of this disclosure, there is provided a method to be executed by a processor 10 of a computer 200 in order to assist input in a virtual space 2 to be provided by an HMD 110. The input may include operation input in order to change a location of an object to be arranged in the virtual space 2. The method includes displaying in the virtual space 2 an object 920 having a changeable arrangement location in the virtual space 2. The method further includes receiving an operation for changing the location of the arranged object 920. The method further includes displaying in the virtual space 2 a guide object (e.g., grid 950) for positioning the object. The method further includes moving the object 920 in the virtual space 2 in accordance with the operation. The method further includes moving the guide object in synchronization with the movement of the object 920.

[Configuration 2]

In at least one embodiment the displaying of the guide object includes displaying a grid 950 parallel to a vertical direction (x-z plane) of the virtual space 2.

[Configuration 3]

In at least one embodiment the displaying of the guide object further includes displaying a grid 940 parallel to an x-y plane of the virtual space 2.

[Configuration 4]

In at least one embodiment the displaying of the grid 940 parallel to the x-y plane includes displaying the grid 940 until a state of the virtual space 2 becomes a state determined in advance. The state determined in advance may be, for example, a state in which an arrangement of a newly-appeared object in the virtual space 2 is complete. The step of displaying the grid 950 includes displaying the grid 950 during a period in which the arrangement of the object 920 is being adjusted. Adjustment of the arrangement of the object 920 includes, for example, arranging the object 920 at a location intended by a user 190 while the object 920 is held by a hand object 930 based on a motion of the user 190 in the virtual space 2.

[Configuration 5]

In at least one embodiment the method further includes, in addition to the above-mentioned configurations, displaying, in response to an operation being received, an operation object (e.g., hand object 930) for performing an operation to move the object. The step of displaying the grid 950 parallel to the vertical direction of the virtual space 2 includes displaying the grid 950 during a period in which the object 920 is held by the operation object.

[Configuration 6]

In at least on embodiment the method further includes arranging the object 920 at a location specified by the guide object in accordance with a movement of the operation object.

[Configuration 7]

In at least one embodiment the displaying of an operation object includes displaying a body object corresponding to any one of both hands, both legs, and two fingers. The step of moving the object in the virtual space 2 includes constraining the object by the body object and a step of moving the constrained object.

[Configuration 8]

In at least one embodiment the method further includes detecting a state of a limb of the user of the head-mounted display device. The step of displaying a body object includes displaying a body object in accordance with the state of the limb.

[Configuration 9]

In at least one embodiment the displaying of an operation object includes displaying, when the object is moving, the operation object in a mode in which the object is constrained, and displaying, after arrangement of the object is complete, the operation object in a mode in which the object is released.

[Configuration 10]

In at least one embodiment the displaying of an object includes displaying the object near the operation object.

[Configuration 11]

In at least one embodiment the method further includes confirming a change in the location of the object, and turning off a display of the guide object in response to confirmation of the change in the location.

[Configuration 12]

In at least one embodiment the arranging of an object includes arranging the object in mid-air in the virtual space.

[Configuration 13]

In at least one embodiment a mode displayed when the object is displayed in the virtual space includes a first mode in which the location of the object is changeable and a second mode in which the location of the object is not changeable. The displaying of a guide object in the virtual space includes a step of displaying the guide object in the first mode.

[Configuration 14]

In at least one embodiment the displaying of the guide object in the first mode includes displaying the guide object when an operation is received.

[Configuration 15]

In at least one embodiment the displaying of an object in the virtual space includes changing a size of the object, and displaying the object having the changed size. The step of displaying a guide object in the virtual space includes displaying, when the size of the object has been changed, the guide object without changing a scale of the guide object.

[Configuration 16]

In at least one embodiment the displaying of an object in the virtual space includes changing a size of the object, and displaying the object having the changed size. The displaying of a guide object in the virtual space includes displaying, in response to the change of the size of the object, the guide object having a changed scale by changing a scale of the guide object.

[Configuration 17]

According to at least one embodiment of this disclosure, a system for executing the method of any of the above-mentioned configurations is provided.

[Configuration 18]

According to at least one embodiment of this disclosure, a device for assisting input in a virtual space is provided. The device includes a memory having a program stored thereon, and a processor, which is coupled to the memory, and is configured to execute the program.

As described above, according to at least one embodiment, when an object is arranged in the virtual space 2, the grid 950 or other guide object is temporarily arranged in the field-of-view region 23. This enables the user 190 wearing the HMD 110 to arrange the object in the virtual space 2 while referring to a guide object, and hence the user 190 may easily arrange the object at an intended location.

[Supplementary Note 2]

[Configuration 21]

According to at least one embodiment of this disclosure, there is provided a method to be executed by a computer for assisting communication in a virtual space 2. The method includes accessing each piece of shape data (e.g., object information 242) associated with one or more conditions determined in advance in order to display each of a plurality of hand objects (e.g., left-hand object 2210 and right-hand object 2220) to be displayed as a hand and finger mode in the virtual space 2 to be provided to a user 190 wearing an HMD 110. The method further includes displaying the hand objects corresponding to hands and fingers of the user 190 wearing the HMD 110 in a first mode (e.g., state in which both hands are open). The method further includes displaying, when an input operation performed by the user 190 wearing the HMD 110 or a positional relationship with another user object in the virtual space 2 has satisfied any of one or more conditions determined in advance, in a second mode (e.g., mode during shaking hands) different from the first mode, a hand object (e.g., right-hand object 2220) displayed in the virtual space 2 based on shape data associated with the condition determined in advance.

[Configuration 22]

In at least one embodiment the method further includes displaying in the virtual space 2 a list object 2230 showing a list including each of the plurality of hand objects, and selecting any of the hand objects from the list object based on a selection operation performed in the virtual space 2 in accordance with a motion of the user 190 in a real space. The displaying in the second mode of the hand object displayed in the virtual space 2 includes displaying the selected hand object in the virtual space 2. For example, when the right-hand object 2220 selects in the virtual space 2 a hand object 2232 making a V-sign, the right-hand object 2220 arranged in the virtual space 2 switches to the hand object 2232 making a V-sign.

[Configuration 23]

In at least one embodiment the displaying in the virtual space 2 of the list object 2230 includes displaying, based on a motion of the user 190 in the real space, the list object 2230 near the hand object (e.g., above the index finger of the left-hand object 2210) displayed in the virtual space 2.

[Configuration 4]

In at least one embodiment the displaying in the second mode of the hand object displayed in the virtual space 2 includes displaying, when a positional relationship with another user in the virtual space 2 is recognizable by the user 190 wearing the HMD 110 (e.g., in a conversational state with another player 2310), a hand object defined in advance as a mode (e.g., hand-shaking mode) for communicating with the another player 2310.

[Configuration 25]

In at least one embodiment the displaying of a hand object defined in advance includes displaying a hand object (e.g., right-hand object 2320) defined in advance when another user (e.g., another player 2310) is recognizable in a range of a visual field (field-of-view region) of the user 190 in the virtual space 2.

[Configuration 26]

In at least one embodiment the range of the visual field includes a distance from the user 190 to the another user in the virtual space 2 that is equal to or less than a distance defined in advance.

[Configuration 27]

In at least one embodiment the displaying of a hand object defined in advance includes at least any one of displaying in the virtual space 2 a list object showing a list including each of the plurality of hand objects based on a motion of the user 190, displaying in the virtual space 2 a list object based on an automatic display setting selected in advance, or displaying a hand object associated with an automatic display setting enabled in advance.

[Configuration 28]

In at least one embodiment the method further includes receiving an operation (e.g., operation for ending the program being executed by the computer 200) for departing from the virtual space 2 based on a motion of the user 190 in the real space, and a step of displaying in the virtual space 2 a hand object (e.g., hand object representing a hand waving gesture) selected from the plurality of hand objects as the hand object to be displayed when departing from the virtual space 2.

[Configuration 29]

In at least one embodiment a motion defined in advance (e.g., motion of waving a hand left and right or up and down) is associated with each of one or more hand objects of the plurality of hand objects. The displaying of the hand object in the second mode includes displaying the hand object in the second mode together with the motion defined in advance.

[Configuration 30]

According to at least one embodiment of this disclosure, there is provided a system for executing the method of any of the above-mentioned configurations.

[Configuration 31]

In addition, according to at least one embodiment of this disclosure, there is provided a device for assisting communication in the virtual space 2. The device includes a memory 11 configured to store the above-mentioned program, and a processor 10, which is coupled to the memory 11, and is configured to execute the method.

As described above, according to at least one embodiment of the disclosed technical idea, the mode of the hand object to be displayed in the virtual space 2 changes to a mode in accordance with the communication to/from another party, and hence communication in the virtual space 2 may be promoted.

[Supplementary Note 3]

[Configuration 41]

According to at least one embodiment of this disclosure, there is provided a method to be executed by a computer 200 in order to control an object to be displayed in a virtual space 2. The method includes defining the virtual space 2 to be provided by an HMD 110. The method further includes arranging in the virtual space 2 a controller object 2500 or 2600 configured to receive control in the virtual space 2. The method further includes detecting a state of any limb (hand or leg) of a user 190 wearing the HMD 110. The method further includes arranging in the virtual space 2 a limb object (e.g., right-hand object or right-leg object) corresponding to the any limb. The method further includes moving, when the limb object and the controller object 2500 or 2600 are associated with each other, the controller object 2500 or 2600 based on a motion of the limb object in synchronization with a motion of the user 190. The method further includes receiving a movement of the controller object 2500 or 2600 as input to the controller object 2500 or 2600.

[Configuration 42]

In at least one embodiment the method further includes moving, when the limb object and the controller object 2500 or 2600 are not associated with each other, the limb object based on the motion of the user 190.

[Configuration 43]

In at least one embodiment the method further includes associating the limb object and the controller object 2500 or 2600 with each other based on a movement of the limb object in synchronization with a motion of the user 190. For example, the processor 10 associates coordinate values of a right-hand object with coordinate values of the controller object 2500 and stores in a memory 11 those coordinate values.

[Configuration 44]

In at least one embodiment the association of the limb object with the controller object 2500 or 2600 is performed in response to contact between the limb object and the controller object 2500 or 2600 in the virtual space 2. For example, when the coordinate values of the right-hand object and the coordinate values of a part of the controller object 2500 are the same values, the right-hand object and the controller object 2500 are associated with each other.

[Configuration 45]

In at least one embodiment the controller object 2500 or 2600 includes a rotation object configured to receive a rotation operation. The moving of the controller object 2500 or 2600 includes causing the rotation object to rotate. For example, the controller object 2500 or 2600 rotates about a rotation axis determined in advance.

[Configuration 46]

In at least one embodiment the controller object 2500 or 2600 includes a stick object configured to receive an operation at least in one direction. The moving of the controller object 2500 or 2600 includes causing the stick object to move in at least one direction in synchronization with a motion in at least one direction (e.g., any of up, down, left, and right directions) of the user 190.

For example, in the method, when one stick object is arranged in the virtual space 2, the step of moving a controller object includes causing, by associating the limb object and the stick object with each other, the stick object to be moved such that the stick object is inclined. For example, when the stick object is regarded as a control stick for steering a moving object, for example, a flight vehicle, the computer 200 can receive control stick operations as input for causing the moving object to move in accordance with the inclination of the stick object. The computer 200 is configured to generate a field-of-view image by controlling the arrangement (e.g., inclination) of a virtual camera in the virtual space 2 in accordance with the inclination of the stick object. For example, an operation for inclining the stick object in the front-rear direction may be received, and the virtual camera may be rotated about the pitch direction axis. In the method described above, when two stick objects are arranged in the virtual space 2, the step of moving a controller object includes causing, by associating the limb object and the stick objects with each other, the stick objects to be moved such that the stick objects are inclined. For example, the two stick objects may be regarded as two levers for causing a tank or other moving object to move, and an operation for tilting the levers may be received as input for steering the moving object. In this case, for example, by associating one of the two stick objects with a right-hand object, and associating the other of the two stick objects with a left-hand object, the computer 200 can receive stick operations as input for causing the moving object to move in accordance with the inclination of each of the stick objects.

[Configuration 47]

In at least one embodiment the arranging of the controller object 2500 or 2600 in the virtual space 2 includes arranging the controller object 2500 or 2600 in the virtual space 2 based on a motion of the user 190.

[Configuration 48]

In at least one embodiment the arranging of the controller object 2500 or 2600 in the virtual space 2 includes arranging the controller object 2500 or 2600 in the virtual space 2 in accordance with progression in a scenario of a program providing the virtual space 2.

[Configuration 49]

According to at least one embodiment of this disclosure, there is provided a system for executing the method of any of the above-mentioned configurations.

[Configuration 50]

In addition, according to at least one embodiment of this disclosure, there is provided a control device for an object displayed in the virtual space 2. The control device includes the memory 11 configured to store a program, and the processor 10, which is coupled to the memory 11, and is configured to execute the program for executing the method.

As described above, according to the HMD system 100 of at least one embodiment of this disclosure, hand objects are arranged in the virtual space 2. When a condition determined in advance for arranging a controller object in the virtual space 2 under a state in which the hand objects are arranged is satisfied, the controller object is also arranged in the virtual space 2. When a condition determined in advance for associating the hand objects and the controller object with each other is satisfied, the hand objects and the controller object are associated with each other. When the user 190 moves his or her hand, the hand object moves in accordance with that movement, and the controller object also operates in synchronization with the movement of the hand object. In this manner, objects arranged in the virtual space 2 can be operated not only by the hand object but also by using the controller object, and hence a variety of input operations can be achieved.

[Supplementary Note 4]

(Configuration 51)

There is provided a method to be executed by a processor 10 in order to provide a virtual space by displaying an image on an HMD 110. The method includes defining a virtual space 2 (Step S3610). The method further includes displaying in the virtual space 2 an operation object for receiving an operation performed by a user of the HMD 110 in the virtual space 2 (Step S3620). The method further includes detecting a motion of a part of a body of the user (Step S3650). The method further includes moving the operation object in synchronization with the detected motion (Step S3660). The method further includes monitoring a monitoring target and changing a display mode of the operation object or an accompanying object accompanying the operation object in accordance with a change in the monitoring target (Step S3640).

(Configuration 52)

In Configuration 51, the monitoring target can be represented by a numerical value. The changing of the display mode includes changing the display mode of the operation object or the accompanying object when a magnitude relationship between the numerical value of the monitoring target and a threshold value determined in advance has reversed.

(Configuration 53)

In Configuration 52, the monitoring target includes a numerical value indicating a ratio.

(Configuration 54)

In Configuration 52 or Configuration 53, the detecting of a motion includes detecting a motion of a part of a body of a user based on output from a controller 160 (motion sensor 130) worn by the user. The monitoring target includes a remaining power of a battery 805 of the controller 160.

(Configuration 55)

In Configuration 52 or Configuration 53, the monitoring target includes a playing time of a game provided in the virtual space 2.

(Configuration 56)

In Configuration 52 or Configuration 53, the monitoring target includes an amount of money paid in the game provided in the virtual space 2.

(Configuration 57)

In Configuration 52 or Configuration 53, the monitoring target includes a parameter value determined in advance for a game provided in the virtual space 2.

(Configuration 58)

In Configuration 51, a processor 10 is capable of communicating to/from another computer. In addition, the monitoring target includes presence or absence of communication from the other computer.

(Configuration 59)

In Configuration 51 to Configuration 56, the detecting of a motion includes detecting any limb of the user. The operation object includes a limb object (e.g., virtual hand objects 3710 and 3720) having a shape corresponding to the any limb.

(Configuration 60)

In Configuration 51 to Configuration 59, the changing of a display mode includes changing a color or a pattern of the operation object or the accompanying object.

(Configuration 61)

In Configuration 51 to Configuration 59, the changing of a display mode includes changing a transmittance of the operation object or the accompanying object.

(Configuration 62)

In Configuration 51 to Configuration 59, the changing of a display mode includes degrading the operation object or the accompanying object.

It is to be understood that embodiments disclosed above are merely examples in all aspects and in no way intended to limit this disclosure. Further, it is to be understood that the plurality of disclosed embodiments may be combined as appropriate. The scope of this disclosure is defined by the appended claims and not by the embodiments, and it is intended that modifications made within the scope and spirit equivalent to those of the claims are duly included in this disclosure.

1-13. (canceled)

14. A method to be executed by a computer, the method comprising:
defining a virtual space;
displaying an operation object in the virtual space;
detecting a motion of a part of a body of a user;
moving the operation object in the virtual space in synchronization with the detected motion;
monitoring a status of a monitoring target outside the virtual space; and
changing a display mode of the operation object or an accompanying object associated with the operation object in response to a change in the status of the monitoring target.

15. The method according to claim 14,
wherein the monitoring target is represented by a numerical value, and
the changing of the display mode comprises changing the display mode in response to the numerical value being equal to or less than a predetermined threshold value.

16. The method according to claim 14,
wherein the detecting of the motion comprises detecting motion of a controller worn by the user, and
the monitoring of the monitoring target comprises monitoring a remaining power of a battery for driving the controller.

17. The method according to claim 14, wherein the monitoring of the monitoring target comprises monitoring a playing time of a game provided in the virtual space.

18. The method according to claim 14, wherein the monitoring of the monitoring target comprises monitoring an amount of money paid for playing a game provided in the virtual space.

19. The method according to claim 14, wherein the monitoring of the monitoring target comprises monitoring a parameter value determined in advance for a game provided in the virtual space.

20. The method according to claim 14, wherein computer is capable of communicating with a second computer via a network, and
wherein the monitoring of the monitoring target comprises monitoring a presence or an absence of communication with the second computer.

21. The method according to claim 14,
wherein detecting the motion comprises detecting motion of a limb of the user, and
the operation object comprises a representation of the limb, wherein the representation of the limb comprises a shape corresponding to the limb.

22. The method according to claim 14, wherein the changing of the display mode comprises changing a color or a pattern of the operation object or of the accompanying object.

23. The method according to claim 14, wherein the changing of the display mode comprises changing a transmittance of the operation object or of the accompanying object.

24. The method according to claim 14, wherein the changing of the display mode comprises changing a degradation level of the operation object or of the accompanying object.

25. A system comprising:
a head mounted display wearable by a user;
a controller wearable by the user; and
a controller in communication with the head mounted display and the controller, wherein the controller is configured to execute instructions for:
defining a virtual space to be displayed by the head mounted display, wherein the virtual space comprises an operation object;
detecting a motion of a part of a body of a user using the controller;
providing instructions for moving the operation object in the virtual space in synchronization with the detected motion;
monitoring a status of a monitoring target outside the virtual space; and
providing instructions for changing a display mode of the operation object or an accompanying object associated with the operation object in response to a change in the status of the monitoring target.

26. The system according to claim 25, wherein the monitoring target is a remaining power of a battery for driving the controller.

27. The system according to claim 25, wherein the monitoring target comprises a playing time of a game in the virtual space.

28. The system according to claim 25, wherein the monitoring target comprises an amount of money paid for playing a game in the virtual space.

29. The system according to claim 25, wherein the monitoring target comprises a parameter value determined in advance for a game in the virtual space.

30. The system according to claim 25, wherein controller is capable of communicating with a computer via a network, and
the controller is configured to monitor the monitoring target based on a presence or an absence of communication with the computer.

31. The system according to claim 25, wherein the controller is configured to provide instruction for changing of the display mode by providing instructions for changing a color or a pattern of the operation object or of the accompanying object in the virtual space.

32. The system according to claim 25, wherein the controller is configured to provide instructions for changing of the display mode by providing instructions for changing a transmittance of the operation object or of the accompanying object in the virtual space.

33. An information processing device, comprising:
a memory for storing instructions; and
a processor configured to execute the instructions for:
defining a virtual space to be displayed by the head mounted display, wherein the virtual space comprises an operation object;
detecting a motion of a part of a body of a user;
providing instructions for moving the operation object in the virtual space in synchronization with the detected motion;
monitoring a status of a monitoring target outside the virtual space; and
providing instructions for changing a display mode of the operation object or an accompanying object associated with the operation object in response to a change in the status of the monitoring target.
